(19) United States
(12) Patent Application Publication
(10) Pub. No.: US 2018/0196867 A1
(43) Pub. Date: Jul. 12, 2018

(54) SYSTEM, METHOD AND COMPUTER PROGRAM PRODUCT FOR ANALYTICS ASSIGNMENT

(71) Applicants: Alexander WIESMAIER, Ober-Ramstadt (DE); Oliver HALLER, Rodgau (DE); Moritz BORGMANN, Darmstadt (DE)

(72) Inventors: Alexander WIESMAIER, Ober-Ramstadt (DE); Oliver HALLER, Rodgau (DE); Moritz BORGMANN, Darmstadt (DE)

(21) Appl. No.: 15/865,472

(22) Filed: Jan. 9, 2018

Related U.S. Application Data
(60) Provisional application No. 62/443,974, filed on Jan. 9, 2017.

(51) Int. Cl. G06F 17/30

(52) U.S. Cl. CPC G06F 17/30598; G06F 17/30516

(57) ABSTRACT

Assistant serving a software platform which operates intermittently on use cases, comprising:
a. an interface receiving
a formal description of the use cases including a characterization of each along dimensions; and
a formal description of the platform's possible configurations including a formal description of execution environments supported by the platform including for each environment a characterization thereof along the dimensions; and
b. a categorization module including processor circuitry operative to assign an execution environment to each use-case,
wherein at least one characterization is ordinal wherein the ordinality is defined such that if characterizations of an environment are along at least one of the dimensions respectively >=characterizations of a use case, the environment can be used to execute the use case,
the categorization module generating assignments which assign to use-case U, an environment whose characterizations are respectively >=the characterizations of U along each dimension.

### REFERENCE TO CO-PENDING APPLICATIONS

Priority is claimed from U.S. provisional application No. 62/443,974, entitled ANALYTICS PLATFORM and filed on 9 Jan. 2017, the disclosure of which application/s is hereby incorporated by reference.

### FIELD OF THIS DISCLOSURE

The present invention relates generally to software, and more particularly to analytics software such as IoT analytics.

### BACKGROUND FOR THIS DISCLOSURE

Wikipedia describes that “Serverless computing is a cloud computing execution model in which the cloud provider dynamically manages the allocation of machine resources. Pricing is based on the actual amount of resources consumed by an application, rather than on pre-purchased units of capacity. It is a form of utility computing. Serverless computing still requires servers, hence it is a misnomer. The name “serverless computing” is used because the server management and capacity planning decisions are completely hidden from the developer or operator. Serverless code can be used in conjunction with code deployed in traditional styles, such as microservices. Alternatively, applications can be written to be purely serverless and use no provisioned services at all. Serverless computing is more cost-effective than renting or purchasing a fixed quantity of servers, which generally involves significant periods of underutilization or idle time. It can even be more cost-efficient than provisioning an autoscaling group, due to more efficient bin-packing of the underlying machine resources. In addition, a serverless architecture means that developers and operators do not need to spend time setting up and tuning autoscaling policies or systems; the cloud provider is responsible for ensuring that the capacity always meets the demand. AWS Lambda, introduced by Amazon in 2014, was the first public cloud vendor with an abstract serverless computing offering”.

Wikipedia defines that “AWS Lambda is an event-driven, serverless computing platform provided by Amazon as a part of the Amazon Web Services. It is a compute service that runs code in response to events and automatically manages the compute resources required by that code. It was introduced in 2014. The purpose of Lambda, as compared to AWS EC2, is to simplify building smaller, on-demand applications that are responsive to events and new information. AWS targets starting a Lambda instance within milliseconds of an event”.

US Patent document US2009248722 describes a system for clustering analytic functions. Given information about a set of analytic function instances and time series data the system uses a rule based engine to cluster subsets of time series analytics into groups taking into account the dependencies between analytics function instance.

US Patent document US 20120066224 describes improved clustering of analytics functions in which a system is operative to identify a set of instances of an analytic function receiving data input from a set of data sources. A first subset of instances is configured to receive input from a first subset of data sources, and a second subset of instances is configured to receive input from a second subset of data sources. The embodiments assign the set of instances to a cluster. The system may begin executing the cluster in a computer in the data processing environment, when the first subset of data sources begins transmitting time series data input to the first subset of instances in the cluster.

Conventional technology constituting background to certain embodiments of the present invention is described in the following publications inter alia:

[1]Airflow Documentation. Concepts. The Apache Software Foundation. 2016. url: https://airflow.apache.org/concepts.html (last visited on Dec. 10, 2016).

[2]Airflow Documentation. Scheduling & Triggers. The Apache Software Foundation. 2016. url: https://airflow.apache.org/scheduler.html (last visited on Dec. 10, 2016).

[3]Tyler Akidau et al. “MillWheel: Fault-Tolerant Stream Processing at Internet Scale”. In: Very Large Data Bases. 2013, pp. 734-746.

[4]Tyler Akidau et al. “The Dataflow Model: A Practical Approach to Balancing Correctness, Latency, and Cost in Massive-Scale, Unbounded, Out-of-Order Data Processing”. In: Proceedings of the VLDB Endowment 8 (2015), pp. 1792-1803.

[5]Amazon Athena User Guide. What is Amazon Athena? Amazon Web Services, Inc. 2016. url: https://docs.aws.amazon.com/athena/latest/ug/what-is.html (last visited on Dec. 10, 2016).

[6]Amazon DynamoDB Developer Guide. Amazon Web Services, Inc., 2016. Chap. DynamoDB Core Components, pp. 3-8.

[7]Amazon DynamoDB Developer Guide. Amazon Web Services, Inc., 2016. Chap. Provisioned Throughput, pp. 16-21.

[8]Amazon DynamoDB Developer Guide. Amazon Web Services, Inc., 2016. Chap. Limits in DynamoDB, pp. 607-613.

[9]Amazon Elastic MapReduce Documentation. Apache Flink. Amazon Web Services, Inc. 2016. url: http://docs.aws.amazon.com/ElasticMapReduce/latest/ReleaseGuide/emr-flink.html (last visited on Dec. 30, 2016).

[10] Amazon Elastic MapReduce Documentation Release Guide. Applications. Amazon Web Services, Inc. 2016. url: http://docs.aws.amazon.com//ElasticMapReduce/latest/ReleaseGuide/emr-release-components.html#d0e650 (last visited on Dec. 13, 2016).

[11] Amazon EMR Management Guide. Amazon Web Services, Inc., 2016. Chap. File Systems Compatible with Amazon EMR, pp. 50-57.

[12] Amazon EMR Management Guide. Amazon Web Services, Inc., 2016. Chap. Scaling Cluster Resources, pp. 182-191.

[13] Amazon EMR Release Guide. Hue. Amazon Web Services, Inc. 2016. url: https://docs.aws.amazon.com/ElasticMapReduce/latest/ReleaseGuide/emr-hue.html (last visited on Dec. 10, 2016).

[14] Amazon Kinesis Firehose. Amazon Web Services, Inc., 2016. Chap. Amazon Kinesis Firehose Data Delivery, pp. 27-28.

[15] Amazon Kinesis Firehose. Amazon Web Services, Inc., 2016. Chap. Amazon Kinesis Firehose Limits, p. 54.

[16] Amazon Kinesis Streams API Reference. UpdateShardCount. Amazon Web Services, Inc. 2016. url:http://docs.aws.amazon.com/kinesis/latest/APIReference/API_UpdateShardCount.html (last visited on Dec. 11, 2016).

[17] Amazon Kinesis Streams Developer Guide. Amazon Web Services, Inc., 2016. Chap. Streams High-level Architecture, p. 3.

[18] Amazon Kinesis Streams Developer Guide. Amazon Web Services, Inc., 2016. Chap. What Is Amazon Kinesis Streams?, pp. 1-4.

[19] Amazon Kinesis Streams Developer Guide. Amazon Web Services, Inc., 2016. Chap. Working With Amazon Kinesis Streams, pp. 96-101.

[20] Amazon Kinesis Streams Developer Guide. Amazon Web Services, Inc., 2016. Chap. Amazon Kinesis Streams Limits, pp. 7-8.

[21] Amazon RDS Product Details. Amazon Web Services, Inc. 2016. url: https://aws.amazon.com/rds/details/ (last visited on Jan. 1, 2017).

[22] Amazon Simple Storage Service (S3) Developer Guide. Bucket Restrictions and Limitations. Amazon Web Services, Inc. 2016. url: http://docs.aws.amazon.com/AmazonS3/latest/dev/BucketRestrictions.html (last visited on Dec. 13, 2016).

[23] Amazon Simple Storage Service (S3) Developer Guide. Request Rate and Performance Considerations. Amazon Web Services, Inc. 2016. url: http://docs.aws. amazon.com/AmazonS3/latest/dev/request rate perf—considerations.html (last visited on Dec. 23, 2016).

[24] Amazon Simple Workflow Service Developer Guide. Amazon Web Services, Inc., 2016. Chap. Basic Concepts in Amazon SWF, pp. 36-51.

[25] Amazon Simple Workflow Service Developer Guide. Amazon Web Services, Inc., 2016. Chap. AWS Lambda Tasks, pp. 96-98.

[26] Amazon Simple Workflow Service Developer Guide. Amazon Web Services, Inc., 2016. Chap. Development Options, pp. 1-3.

[27] Amazon Simple Workflow Service Developer Guide. Amazon Web Services, Inc., 2016. Chap. Amazon Simple Workflow Service Limits, pp. 133-137.

[28] Ansible Documentation. Amazon Cloud Modules. Red Hat, Inc. 2016. url: http://docs.ansible.com/ansible/list_of_cloud_modules.html# amazon (last visited on Dec. 9, 2016).

[29] Ansible Documentation. Create or delete an AWS CloudFormation stack. Red Hat, Inc. 2016. url: http://docs.ansible.com/ansible/cloudformation_module.html (last visited on Dec. 9, 2016).

[30] Apache Airflow (incubating) Documentation. The Apache Software Foundation. 2016. url: https://airflow.apache.org/#apache airflow—incubating-documentation (last visited on Dec. 10, 2016).

[31] Apache Camel. The Apache Software Foundation. 2016. url: http://camel. apache.org/component.html (last visited on Dec. 31, 2016).

[32] Apache Camel Documentation. Camel Components for Amazon Web Services. The Apache Software Foundation. 2016. url: https://camel.apache.org/aws.html (last visited on Dec. 18, 2016).

[33] Apache Flink. Features. The Apache Software Foundation. 2016. url: https://flink.apache.org/features.html (last visited on Dec. 28, 2016).

[34] AWS Batch Product Details. Amazon Web Services, Inc. 2016. url: https://aws.amazon.com/batch/details/ (last visited on Dec. 30, 2016).

[35] AWS CloudFormation User Guide. Amazon Web Services, Inc., 2016. Chap. What is CloudFormation?, pp. 1-2.

[36] AWS CloudFormation User Guide. Amazon Web Services, Inc., 2016. Chap. Template Reference, pp. 425-429.

[37] AWS CloudFormation User Guide. Amazon Web Services, Inc., 2016. Chap. Template Reference, pp. 525-527.

[38] AWS CloudFormation User Guide. Amazon Web Services, Inc., 2016. Chap. Custom Resources, pp. 398-423.

[39] AWS CloudFormation User Guide. Amazon Web Services, Inc., 2016. Chap. Template Reference, pp. 1303-1304.

[40] AWS Data Pipeline Developer Guide. Amazon Web Services, Inc., 2016. Chap. Data Pipeline Concepts, pp. 4-11.

[41] AWS Data Pipeline Developer Guide. Amazon Web Services, Inc., 2016. Chap. Working with Task Runner, pp. 272-276.

[42] AWS Data Pipeline Developer Guide. Amazon Web Services, Inc., 2016. Chap. AWS Data Pipeline Limits, pp. 291-293.

[43] AWS IoT Developer Guide. Amazon Web Services, Inc., 2016. Chap. AWS IoT Components, pp. 1-2.

[44] AWS IoT Developer Guide. Amazon Web Services, Inc., 2016. Chap. Rules for AWS IoT, pp. 122-132.

[45] AWS IoT Developer Guide. Amazon Web Services, Inc., 2016. Chap. Rules for AWS IoT, pp. 159-160.

[46] AWS IoT Developer Guide. Amazon Web Services, Inc., 2016. Chap. Security and Identity for AWS IoT, pp. 75-77.

[47] AWS IoT Developer Guide. Amazon Web Services, Inc., 2016. Chap. Message Broker for AWS IoT, pp. 106-107.

[48] AWS Lambda Developer Guide. Amazon Web Services, Inc., 2016. Chap. AWS Lambda: How It Works, pp. 151, 157-158.

[49] AWS Lambda Developer Guide. Amazon Web Services, Inc., 2016. Chap. Lambda Functions, pp. 4-5.

[50] AWS Lambda Developer Guide. Amazon Web Services, Inc., 2016. Chap. AWS Lambda Limits, pp. 285-286.

[51] AWS Lambda Developer Guide. Amazon Web Services, Inc., 2016. Chap. AWS Lambda: How It Works, pp. 152-153.

[52] AWS Lambda Pricing. Amazon Web Services, Inc. 2016. url: https://aws. amazon.com/lambda/pricing/#lambda (last visited on Dec. 11, 2016).

[53] Azkaban 3.0 Documentation. Overview. 2016. url: http://azkaban.github.io/azkaban/docs/latest/#overview (last visited on Dec. 11, 2016).

[54] Azkaban 3.0 Documentation. Plugins. 2016. url: http://azkaban.github. io/azkaban/docs/latest/#plugins (last visited on Dec. 11, 2016).

[55] Ryan B. AWS Developer Forums. Thread: Rules engine->Action->Lambda function. Amazon Web Services, Inc. 2016. url: https://forums.aws.amazon.com/message.jspa? messageID=701402 #701402 (last visited on Dec. 9, 2016).

[56] Andrew Banks and Rahul Gupta, eds. MATT Version 3.1.1. Quality of Service levels and protocol flows. OASIS Standard. 2014. url: http://docs.oasis open.org/mqtt/mqtt/v3.1.1/os/mqttv3.1.1os.html #_Ref363045966 (last visited on Dec. 9, 2016).

[57] Erik Bernhardsson and Elias Freider. Luigi 2.4.0 documentation. Getting Started. 2016. url: https://luigi.readthedocs.io/en/stable/index.html (last visited on Dec. 9, 2016).

[58] Erik Bernhardsson and Elias Freider. Luigi 2.4.0 documentation. Execution Model. 2016. url: https://luigi.readthedocs.io/en/stable/execution_model.html (last visited on Dec. 9, 2016).

[59] Erik Bernhardsson and Elias Freider. Luigi 2.4.0 documentation. Design and limitations. 2016. url: https://luigi.readthedocs.io/en/stable/design_and_limitations.html (last visited on Dec. 9, 2016).

[60] Big Data Analytics Options on AWS. Tech. rep. January 2016.

[61] C. Chen et al. “A scalable and productive workflow-based cloud platform for big data analytics”. In: 2016 IEEE International Conference on Big Data Analysis (ICBDA). March 2016, pp. 1-5.

[62] Core Tenets of IoT. Tech. rep. Amazon Web Services, Inc., April 2016.

[63] Features|EVRYTHNG IoT Smart Products Platform. EVRYTHNG. 2016. url: https://evrythng.com/platform/features/ (last visited on Dec. 28, 2016).

[64] Herodotos Herodotou, Fei Dong, and Shivnath Babu. “No One (Cluster) Size Fits All: Automatic Cluster Sizing for Data-intensive Analytics”. In: Proceedings of the 2nd ACM Symposium on Cloud Computing. ACM. 2011, p. 18.

[65] How AWS IoT Works. Amazon Web Services, Inc. 2016. url: https://aws. amazon.com/de/iot/how-it-works/(last visited on Dec. 29, 2016).

[66] ImmobilienScout24/emr-autoscaling. Instance Group Selection. ImmobilienScout24. 2016. url: https://github.com/ImmobilienScout24/emr-autoscaling#instance-group-selection (last visited on Dec. 11, 2016).

[67] IoT Platform Solution 1 Xivley. LogMeln, Inc. 2016. url: https://www. xively.com/xively-iot-platform (last visited on Dec. 28, 2016).

[68] Jay Kreps. Questioning the Lambda Architecture. The Lambda Architecture has its merits, but alternatives are worth exploring. LinkedIn Corporation. Jul. 2, 2014. url: https://www.oreilly.com/ideas/questioning the—lambda-architecture (last visited on Dec. 21, 2016).

[69] Jay Kreps. The Log: What every software engineer should know about realtime data's unifying abstraction. LinkedIn Corporation. Dec. 16, 2013. url: https://engineering. linkedin.com/distributed systems/log—what every software engineer should know about real time—datas-unifying (last visited on Dec. 29, 2016).

[70] Zhenlong Li et al. “Automatic Scaling Hadoop in the Cloud for Efficient Process of Big Geospatial Data”. In: ISPRS International Journal of Geo-Information 5.10 (2016), p. 173.

[71] Pedro Martins, Maryam Abbasi, and Pedro Furtado. “AScale: Auto-Scale in and out ETL+Q Framework”. In: Beyond Databases, Architectures and Structures. Advanced Technologies for Data Mining and Knowledge Discovery. Springer International Publishing Switzerland 2016, 2016.

[72] Nathan Marz and James Warren. Big Data. Principles and best practices of scalable realtime data systems. Greenwich, Conn., USA: Manning Publications Co., May 7, 2015, pp. 14-20.

[73] Angela Merkel. Merkel: Wir müssen uns sputen. Ed. by Presse and Informationsamt der Bundesregierung. Mar. 12, 2016. url: https://www. bundesregierung.de/Content/DE/Pressemitteilungen/BPA/2016/03/2016-03-12-podcast.html (last visited on Dec. 13, 2016).

[74] Kief Morris. Infrastructure as Code. Managing Servers in the Cloud. Sebastopol, Calif., USA: O'Reilly Media, Inc, 2016. Chap. Challenges and Principles, pp. 10-16.

[75] Oozie. Workflow Engine for Apache Hadoop. The Apache Software Foundation. 2016. url: https://oozie.apache.org/docs/4.3.0/index.html (last visited on Dec. 10, 2016).

[76] Oozie Specification. Parameterization of Workflows. The Apache Software Foundation. 2016. url: https://oozie.apache.org/docs/4.3.0/WorkflowFunctionalSpec. html #_a3_Workflow_Nodes (last visited on Dec. 10, 2016).

[77] Oozie Specification. Parameterization of Workflows. The Apache Software Foundation. 2016. url: https://oozie.apache.org/docs/4.3.0/WorkflowFunctionalSpec. html #_a4_Parameterization_of_Workflows (last visited on Dec. 10, 2016).

[78] Press Release: Worldwide Big Data and Business Analytics Revenues Forecast to Reach $187 Billion in 2019. International Data Corporation. 2016. url: https://www.idc.com/getdoc.jsp?containerId=prUS41306516 (last visited on Dec. 12, 2016).

[79] Puppet module for managing AWS resources to build out infrastructure. Type Reference. Puppet, Inc. 2016. url: https://github.com/puppetlabs/puppetlabs-aws#types (last visited on Dec. 9, 2016).

[80] J. L. Pérez and D. Carrera. “Performance Characterization of the servIoTicy API: An IoT-as-a-Service Data Management Platform”. In: 2015 IEEE First International Conference on Big Data Computing Service and Applications. March 2015, pp. 62-71.

[81] Samza. Comparison Introduction. The Apache Software Foundation. 2016. url: https://samza.apache.org/learn/documentation/0.11/comparisons/introduction.html (last visited on Dec. 29, 2016).

[82] S. Sidhanta and S. Mukhopadhyay. “Infra: SLO Aware Elastic Auto-scaling in the Cloud for Cost Reduction”. In: 2016 IEEE International Congress on Big Data (BigData Congress). June 2016, pp. 141-148.

[83] Spark Streaming. Spark 2.1.0 Documentation. The Apache Software Foundation. 2017. url: https://spark.apache.org/docs/latest/streaming-programming-guide.html (last visited on Jan. 1, 2017).

[84] Alvaro Villalba et al. “servIoTicy and iServe: A Scalable Platform for Mining the IoT”. In: Procedia Computer Science 52 (2015), pp. 1022-1027.

[85] What Is Apache Hadoop? The Apache Software Foundation. 2016. url: https://hadoop.apache.org/#What+Is+Apache+Hadoop%3F (last visited on Dec. 23, 2016).

The Lambda Architecture of prior art FIG. 1a aka FIG. 2.1 is designed to process massive amounts of data using stream and batch processing techniques in two parallel processing layers.

The disclosures of all publications and patent documents mentioned in the specification, and of the publications and patent documents cited therein directly or indirectly, are hereby incorporated by reference. Materiality of such publications and patent documents to patentability is not conceded

### SUMMARY OF CERTAIN EMBODIMENTS

Certain embodiments seek to provide an Analytics Assignment Assistant for mapping to-be-executed analytics to a set of available execution environment, which may be operative in conjunction with an (IoT) analytics platform. These embodiments are particularly useful for deployment of analytics modules in (Social) IoT scenarios, as well as other scenarios. These embodiments are useful in conjunction with already deployed systems such as but not limited to Heed, Scale, PBR, DTA, Industry 4.0, Smart Cities, any (auto-)scaling data ingestion & analytics solution in Cloud, Cluster or on premise.

Certain embodiments seek to provide a “utility” system, method and compute program operative for property-based mapping of data analytics to-be-executed on a platform, to a set of execution environments available on that platform.

Certain embodiments seek to provide a system, method and compute program for executing analytics in conditions where at least one of the following use-case properties: data rates, data granularities, time constraints, state requirements, and resource conditions, vary over time e.g. among use-cases assigned to a given platform. Analytics platforms provide multiple analytics execution environments each respectively optimized to a subset of the aforementioned properties.

Certain embodiments seek to provide a system, method and compute program for assigning analytics use cases to execution classes, including some or all of a multidimensional classification module for creating analytics classes, a clustering module for grouping related classes, and a categorization module to deduct suitable execution environments for the resulting analytics groups.

The following terms may be construed either in accordance with any definition thereof appearing in the prior art literature or in accordance with the specification, or to include in their respective scopes, the following:

Dimension: The term Elasticity as used herein (and similarly, dimensions other than Elasticity referred to herein) refers to a property of applications. It is possible to manually or automatically derive execution environments to be realized based on any or all of the dimensions shown and described herein. Values are defined along the dimensions; e.g. elasticity values are defined along the elasticity dimension. To give another example, the time constraints dimension may have defined there along, “offline” and “online” values, or “real-time”, “near-time”, and “long-time” values, or “streaming” and “batch” values, and so forth. It is appreciated that the elasticity dimension has in the illustrated embodiment 4 values, one of which is “Cluster of given size” aka “static deployment” or “fixed size deployment”. Typically “cluster”, used to denote a value along the elasticity dimension, comprises a set of connected servers. So, use of the term “cluster” here is not relevant to “clustering” in the sense of grouping, as performed by the module in FIG. 9a, of analytics use-cases which are similar e.g. because they have the same values along each of several dimensions as described herein.

Application: Any computer implemented program such as but not limited to video games, databases, trading programs, text editing, calculator, anti virus, photo editor and analytics algorithms and environments such as but not limited to IoT analytics. Examples of commercially available applications include, for example: Outlook, Excel, Word, Adobe Acrobat and Skype.

Use-case: The term “use case” as used herein is intended to include computer software that provides a defined functionality, and typically has an end-user who uses but does not necessarily understand the internals of the software. The term “use case” is defined in the art of software and system engineering term as including “how a user uses a system to accomplish a particular goal. A use case acts as a software modeling technique that defines the features to be implemented and the resolution of any errors that may be encountered.” As used herein the term “use-case” is intended to include a wide variety of use-cases such as but not limited to event detection (say, detection of a jump or other sports event), Degradation Detection, Data transformation, Meta data enrichment, Filtering, Simple analytics, Preliminary results and previews, Advanced analytics, Experimental analytics and Cross-event analytics. Typically, each use case is executed by a software program dedicated to that use case. Plural use-cases may be executed sequentially or in parallel by either dedicated software or respectively configured general engines. This may happen within a single execution environment or within a single platform.

Analytics use case” as used herein is intended to include data transformation operation/s (analytics) which may be executed sequentially or in parallel thereby, in combination, accomplishing a goal. A set of use cases may define features and requirements to be fulfilled by a software system. It is appreciated that a use-case may be applicable in different scenarios e.g. jump detection (detection of a “jump” event, e.g. in sports-IoT, may be applicable both for basketball and for horse-shows.

Platform: The term platform is defined as “A group of technologies used as a base upon which other applications, processes or technologies are developed”. A platform, such as but not limited to AWS may provide software building blocks or processes which may or may not be specific to a respective domain, such as analytics, but is typically not a ready to use application since the “building blocks” still need to be combined to implement specific application logic. An “Analytics platform” is a platform for analytics. Amazon AWS is an example platform which provides a variety of services, such as but not limited to S3 and Kinesis which do not have a specific domain.

“computation environment” aka “execution environment”: Refers to the capability of a deployed system or platform to execute analytics with certain given requirements, along certain dimensions such as but not limited to some or all of: working on data points or data streams, providing real-time execution or not, being stateful or not, being elastic or not. Analytics platforms typically provide multiple execution environments respectively optimized to respective sets of KPIs such as data rates and real time conditions. A platform may provide a single environment or, typically on demand, or selectably, or configureably, N different environments supporting different kinds of scenarios.

A platform often provides plural environments fitting different needs. A platform may offer services like provisioning environments, authentication, storage or monitoring that can be used by its environments. In a cloud-based implementation, the platform may comprise a thin layer on top of the services offered by the cloud provider. “execution environment”: intended to include the processors, networks, operating system which are used to run a given use-case (software application code).

It is appreciated that optionally, dimensions may be added to or removed from, an existing set of dimensions. For example, a dimension may be added or removed by respectively adding a respective field to, or removing a respective field from, the JSON description, which is an advantage of using JSON for the formal description, although this is not mandatory of course, since JSON inherently allows adding and removing fields. Another advantage of using JSON as one possible implementation is that out of the box JSON libraries (programs that can be used by other programs) exist which are operative to compare two JSON files (e.g. analytics use case description vs. execution environment description) and to generate an output indicating whether or not the same fields have the same values, or if there are the same fields at all.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented as appropriate.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

### Embodiment 1

An analytics assignment system (aka assistant) serving a software e.g. IoT analytics platform which operates intermittently on plural use cases, the system comprising:

a. an interface receiving

a formal description of the use cases including a characterization of each use case along predetermined dimensions; and

a formal description of the platform's possible configurations including a formal description of plural execution environments supported by the platform including for each environment a characterization of the environment along the predetermined dimensions; and

b. a categorization module including processor circuitry operative to assign an execution environment to each use-case,

wherein at least one said characterization is ordinal thereby to define, for at least one of the dimensions, ordinality comprising “greater than >/less than </equal=” relationships between characterizations along the dimensions, and wherein the ordinality is defined, for at least one dimension, such that if the characterizations of an environment along at least one of the dimensions are respectively no less than (>=) the characterizations of a use case along at least one of the dimensions, the environment can be used to execute the use case,

and wherein the categorization module is operative to generate assignments which assign to at least one use-case U, an environment E whose characterizations along each of the dimensions are respectively no less than (>=) the characterizations of the use case U along each of the at least one dimensions.

Conventional execution environments include: Storm and Samza for Streaming and Hadoop Map Reduce for batching. Environments supporting both Streaming and batching include Spark, Flink, Apex. To give another example: the four analytics lanes described in FIG. 4.1, are 4 examples of execution environments.

Typically, ordinality is defined between values defined along each dimension. It is appreciated that the dimensions may include the following values and ordinalities respectively:
Stateless<stateful. The ordinality of (at least) this dimension may be reversed
Edge<on premise<hosted
Resource constrained<single server<cluster of given size<100% elastic
Data point<data packet<data shard<data chunk
Batch<streaming. the values along this dimension may be replaced or augmented by: long time<near real time<real time.

The ordinality of dimensions may be reversed (e.g. streaming<batch or stateful<stateless e.g. if execute stateful analytics in stateless environments, if the state handling is done by the analytics code). It is appreciated that, for example, batching can be simulated by a streaming environment by reading the data chunks in small portions and delivering it as a stream.

According to certain embodiments, along each dimension used to describe environments, any analytics that can be executed in an environment to which a lower value is assigned on this dimension, can a fortiori be executed in an environment to which a higher value is assigned on this dimension. Also, according to certain embodiments, if certain analytics or software having a certain value along a certain dimension can be executed in an environment, any analytics or software to which a lower value is assigned on this dimension, can a fortiori be executed in that environment.

According to certain embodiments, ordinality is defined along only some dimensions. There may very well be dimensions which only provide half orders, or no order at all. An example may be a privacy dimension with values such as privacy preserving and not privacy preserving. It is typically not the case, that not privacy preserving analytics can be conducted in privacy preserving environments, or vice versa.

### Embodiment 2

A system according to any embodiment shown and described herein and wherein the categorization module is operative to generate assignments which assign to each use-case U, an environment E whose characterizations along each of the dimensions are respectively no less than (>=) the characterizations of the use case U along each of the dimensions.

### Embodiment 3

A system according to any embodiment shown and described herein and wherein the categorization module is operative to generate assignments which assign to at least one use-case U, an environment E whose characterizations along each of the dimensions are respectively equal to (=) the characterizations of the use case U along each of the dimensions.

### Embodiment 4

A system according to any embodiment shown and described herein and wherein the categorization module is operative to generate assignments which assign to at least one use-case U, an environment E whose characterizations along at least one of the dimensions is/are respectively greater than (>) the characterizations of the use case U along each of the dimensions.

### Embodiment 5

A system according to any embodiment shown and described herein and wherein each said characterization is ordinal thereby to define, for each of the dimensions, ordinality comprising “greater than >/less than </equal=” relationships between characterizations along the dimensions.

### Embodiment 6

A system according to any embodiment shown and described herein and wherein the ordinality is defined, for each dimension, such that if the characterizations of an environment along each of the dimensions are respectively no less than (>=), the characterizations of a use case along each of the dimensions, the environment can be used to execute the use case.

### Embodiment 7

A system according to any embodiment shown and described herein and wherein the dimensions include a state dimension whose values include at least one of stateless and stateful.

### Embodiment 8

A system according to any embodiment shown and described herein and wherein the dimensions include a time constraint dimension whose values include at least one of Batch, streaming, long time, near real time, real time.

### Embodiment 9

A system according to any embodiment shown and described herein and wherein the dimensions include a data granularity dimension whose values include at least one of Data point, data packet, data shard, and data chunk.

### Embodiment 10

A system according to any embodiment shown and described herein and wherein the dimensions include an elasticity dimension whose values include at least one of Resource constrained, single server, cluster of given size, 100% elastic.

### Embodiment 11

A system according to any embodiment shown and described herein and wherein the dimensions include a location dimension whose values include at least one of Edge, on premise, and hosted.

### Embodiment 12

A system according to any embodiment shown and described herein which also includes a classification module including processor circuitry which classifies at least one use case along at least one dimension.

### Embodiment 13

A system according to any embodiment shown and described herein which also includes a clustering module including processor circuitry which joins use cases into a cluster if and only if the use cases all have the same values along all dimensions.

### Embodiment 14

A system according to any embodiment shown and described herein which also includes a configuration module including processor circuitry which handles system configuration.

### Embodiment 15

A system according to any embodiment shown and described herein which also includes a data store which stores at least the use-cases and the execution environments.

### Embodiment 16

A system according to any embodiment shown and described herein wherein the platform intermittently activates environments supported thereby to execute use cases, at least partly in accordance with the assignments generated by the categorization module, including executing at least one specific use-case using the execution environment assigned to the specific use case by the categorization module.

it is appreciated that the platform does not necessarily activate environments supported thereby to execute use cases, exclusively in accordance with the assignments generated by the categorization module because other considerations, such as but not limited to limits and rules and metadata, some or all of which may also be applied. For example, the assignments may indicate that it is possible to execute a smaller analytics (say, data point along the data granularity dimension) in a bigger environment (say, data shard along the data granularity dimension) however this might slow down the whole process hence might not be optimal, or might even be ruled out in terms of runtime requirements.

Alternatively or in addition, a rule may indicate that it is permissible, say, to execute an analytics in an environment, that is 1 greater (the environment's value along a certain dimension is one larger than the use-case's value along the same dimension), but not if it is 2 or more values greater (e.g. along the granularity dimension, if use-case=point, environment=packet−ok; but if use-case=point, environment=shard−not ok).

Alternatively or in addition, there may be 2 or several environments that are greater than or equal to a certain use case along all dimensions (or that are equal thereto along all dimensions) in which case additional considerations may be employed to determine which of the environments to use when executing the use-case. For example, the environment to use might be that which does the job e.g. executes the use case, at least cost in either energy or even monetary terms. Cost may optionally be added as a dimension.

Alternatively or in addition, formal descriptions of (at least) the use cases, some or all, may be augmented by metadata stipulating preferred alternatives from among possible environments that can be used to execute certain use cases, and/or setting limits, including e.g. when to come up with an error message e.g. a certain data point analytics is ok for running in a data packet environment but not ok for running in any environment above the data packet value on the granularity dimension.

Alternatively or in addition, formal descriptions of (at least) the environments, some or all, may be augmented by metadata similarly. For example, a data shard environment is ok with running data shard analytics, but not ok to run data packet analytics and other use-cases whose values along the data granularity dimension is lower than “data packet”. For example, in the syntax described above, the following new fields may be defined:

{
“limits” : {

| | |
|---|---|
| “granularity” | : LIMIT, |
| “timeconstraint” | : LIMIT |

| | |
|---|---|
| “state” | : LIMIT, |

| | |
|---|---|
| “location” | : LIMIT, |
| “elasticity” | : LIMIT |

}

}

To yield an upper limit for analytics use cases and/or a lower limit for execution runtimes.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIGS. 1a, 1b aka FIGS. 2.1, 2.2 respectively are diagrams useful in understanding certain embodiments of the present invention.

FIGS. 2a, 2b aka Tables 3.1, 3.2 respectively are tables useful in understanding certain embodiments of the present invention.

FIGS. 3a-3c aka FIGS. 3.1, 3.2, 4.1 respectively are diagrams useful in understanding certain embodiments of the present invention.

FIGS. 4a-4h aka Tables 5.1-5.8 respectively are tables useful in understanding certain embodiments of the present invention.

FIGS. 5a, 5b, 5c aka listings 5.1, 6.1, 6.2 respectively are listings useful in understanding certain embodiments of the present invention.

FIGS. 6a-6e aka FIGS. 5.1-5.5 respectively are diagrams useful in understanding certain embodiments of the present invention.

FIGS. 7a-7d aka FIGS. 6.1-6.4 respectively as well as FIGS. 8a-8b and 9a-9b are diagrams useful in understanding certain embodiments of the present invention.

In particular:

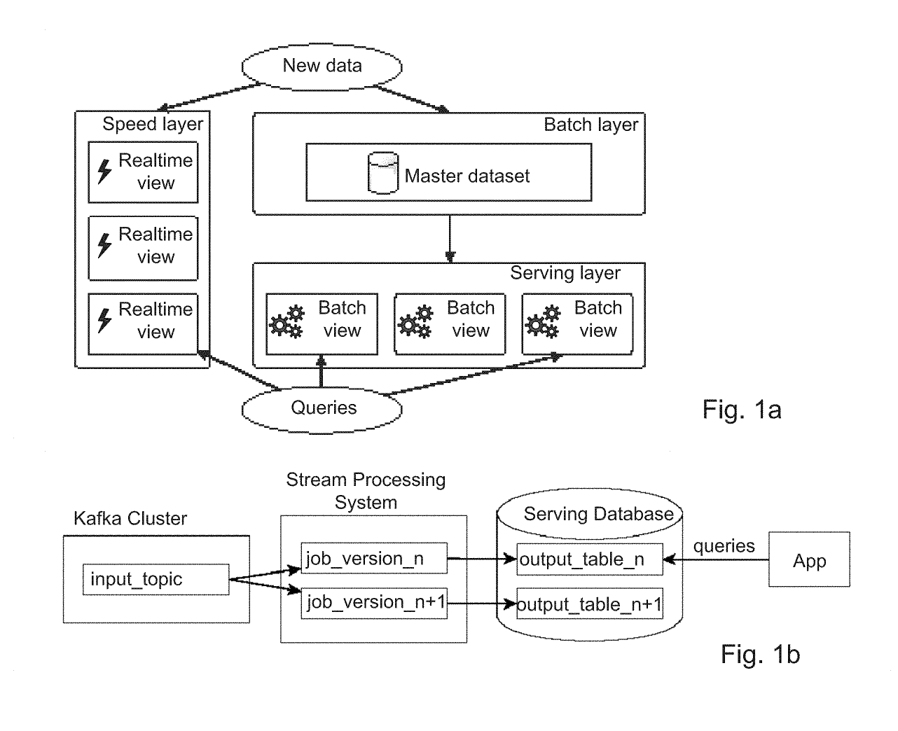

FIG. 1a illustrates a Lambda Architecture;

FIG. 1b illustrates a Kappa Architecture;

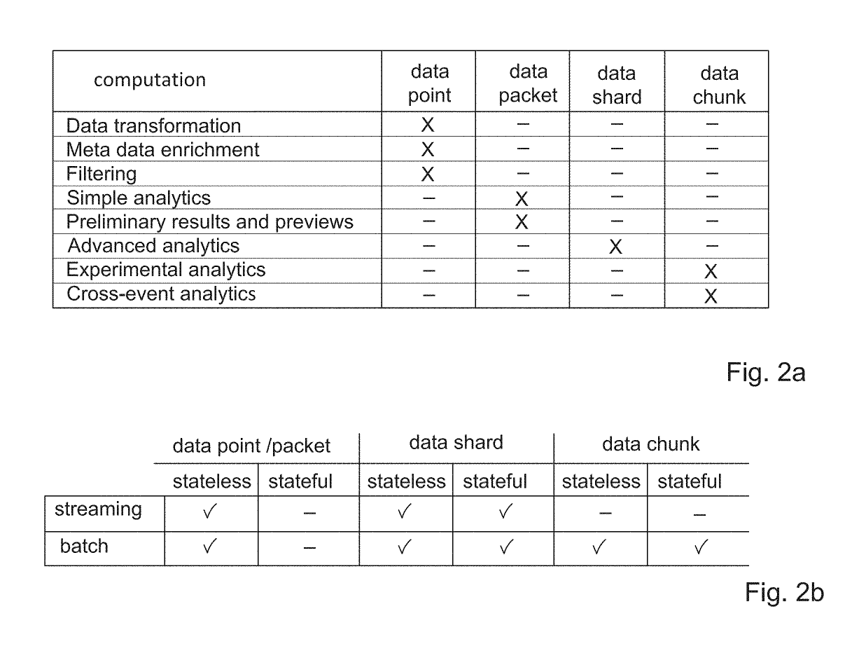

FIG. 2a is a table aka table 3.1 presenting data requirements for different types of use cases;

FIG. 2b is a table aka table 3.2 presenting capabilities of a platform supporting the four base classes;

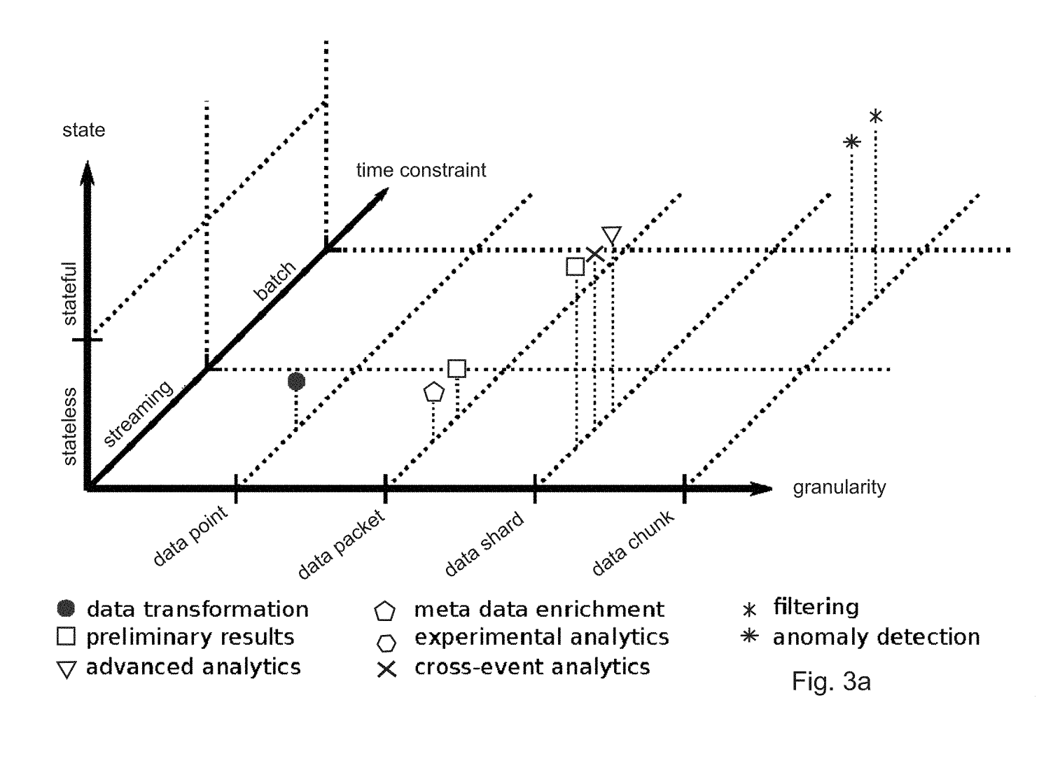

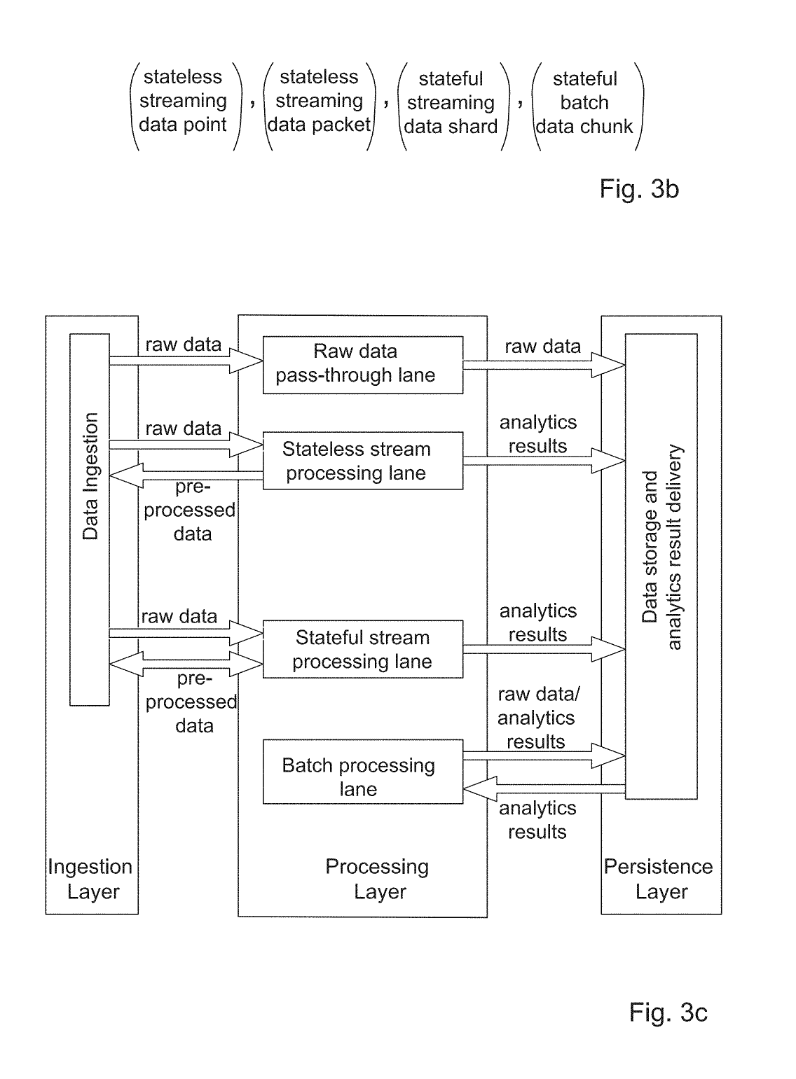

FIG. 3a illustrates dimensions of the computations performed for different use cases;

FIG. 3b illustrates Vector representations of analytics use cases;

FIG. 3c illustrates a high level architectural view of the analytics platform;

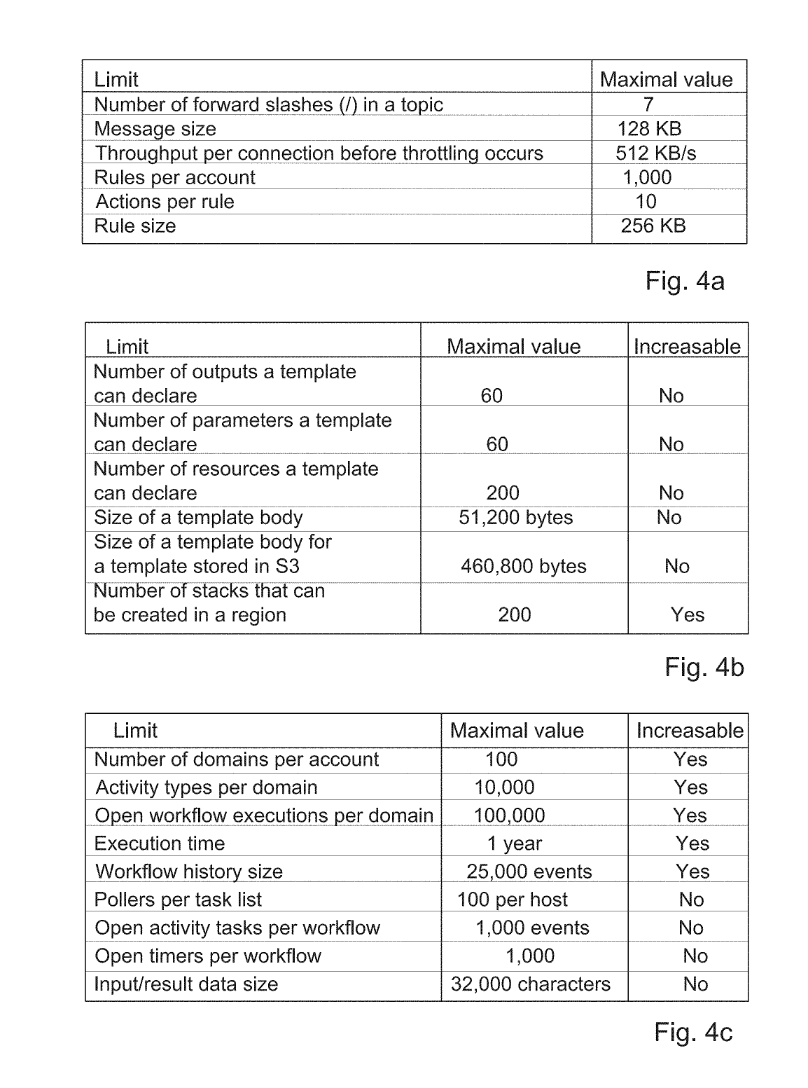

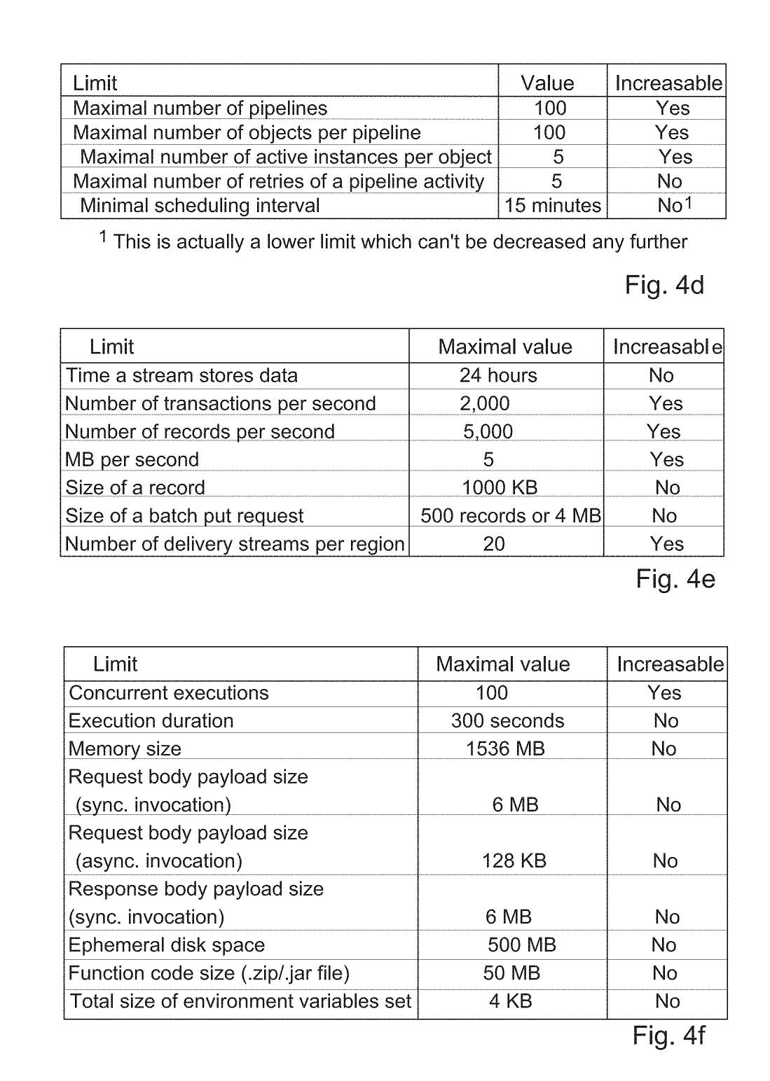

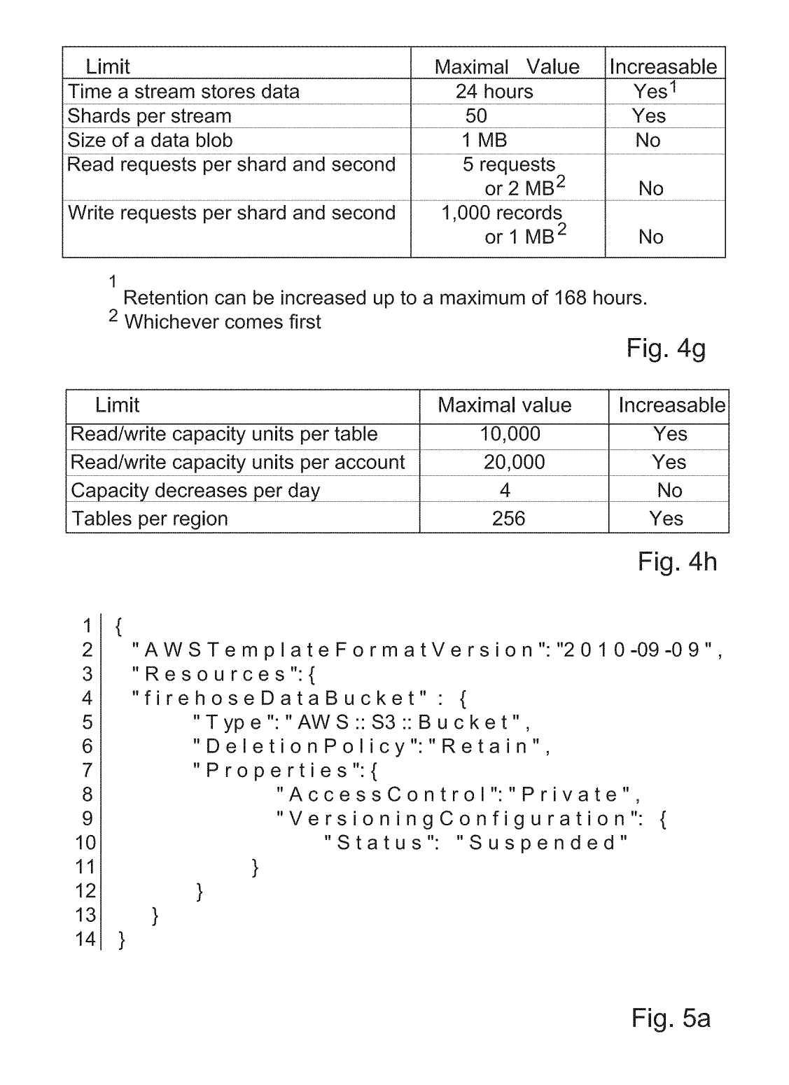

FIG. 4a is a table aka table 5.1 presenting AWS IoT service limit

FIG. 4b is a table aka table 5.2 presenting AWS Cloud Formation service limits;

FIG. 4c is a table aka table 5.3 presenting Amazon Simple Workflow service limits;

FIG. 4d is a table aka table 5.4 presenting AWS Data Pipeline service limits;

FIG. 4e is a table aka table 5.5 presenting Amazon Kinesis Firehose service limits;

FIG. 4f is a table aka table 5.6 presenting AWS Lambda service limits;

FIG. 4g is a table aka table 5.7 presenting Amazon Kinesis Streams service limits;

FIG. 4h is a table aka table 5.8 presenting Amazon DynamoDB service limits;

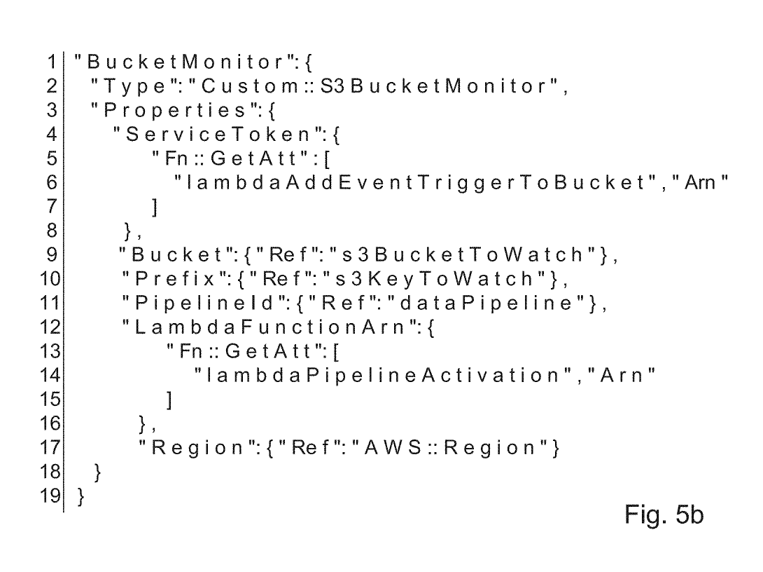

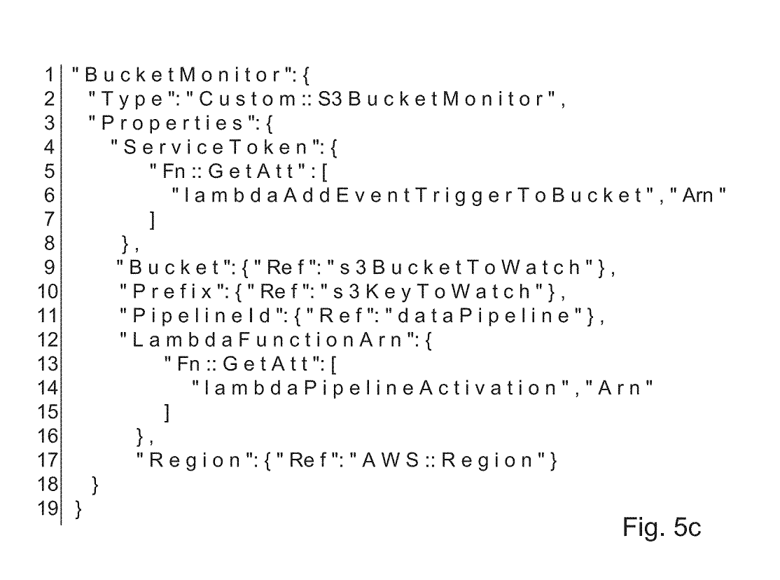

FIG. 5a aka Listing 5.1 is a listing for Creating an S3 bucket with a Deletion Policy in Cloud Formation;

FIG. 5b aka Listing 6.1 is a listing for Creating an AWS IoT rule with a Firehose action in Cloud Formation; and

FIG. 5c aka Listing 6.2 is a listing for BucketMonitor configuration in Cloud Formation.

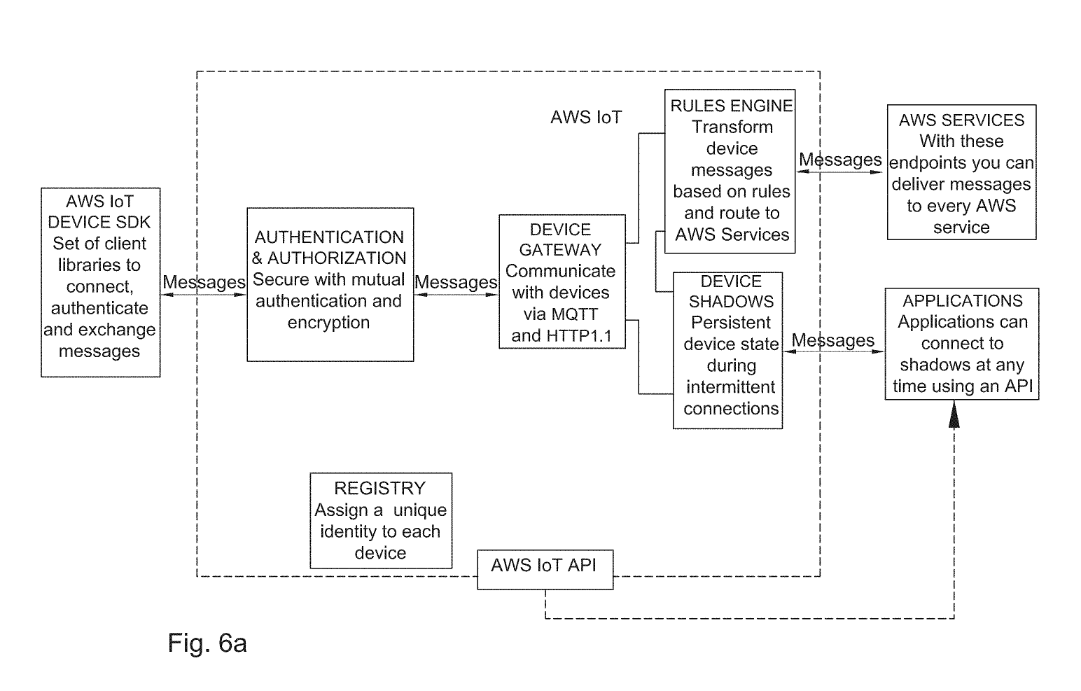

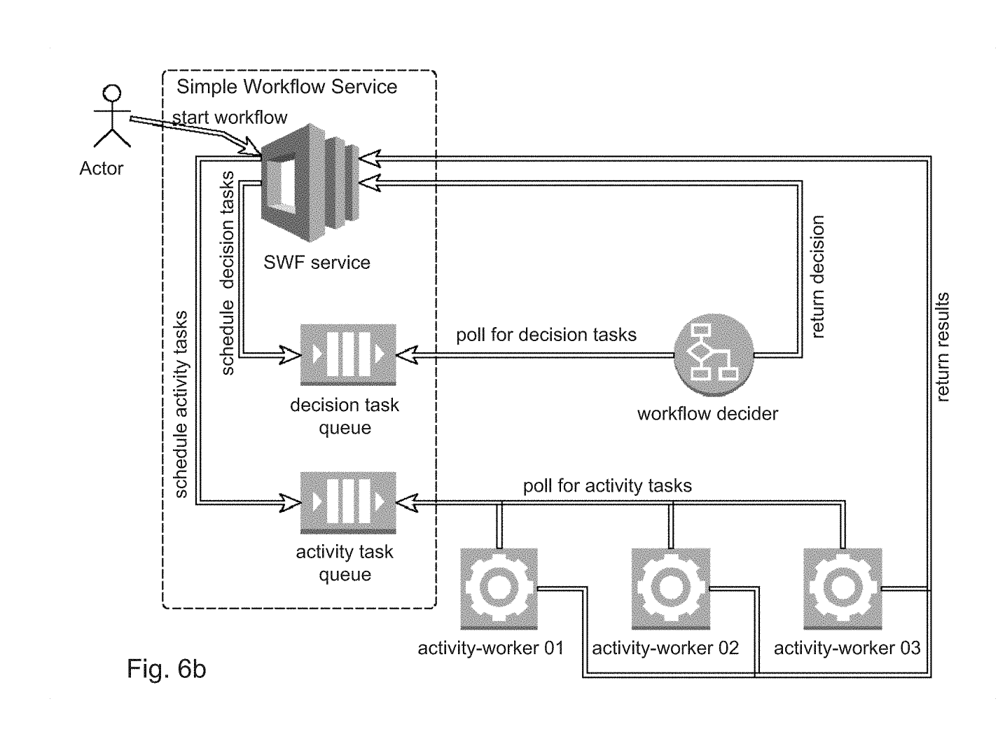

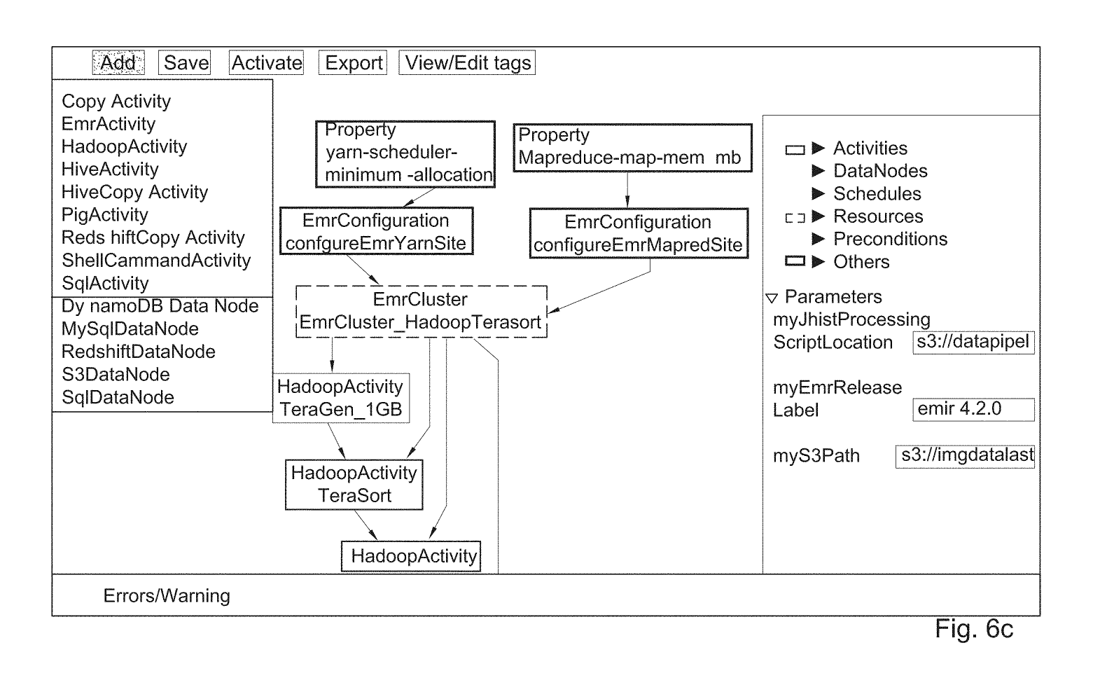

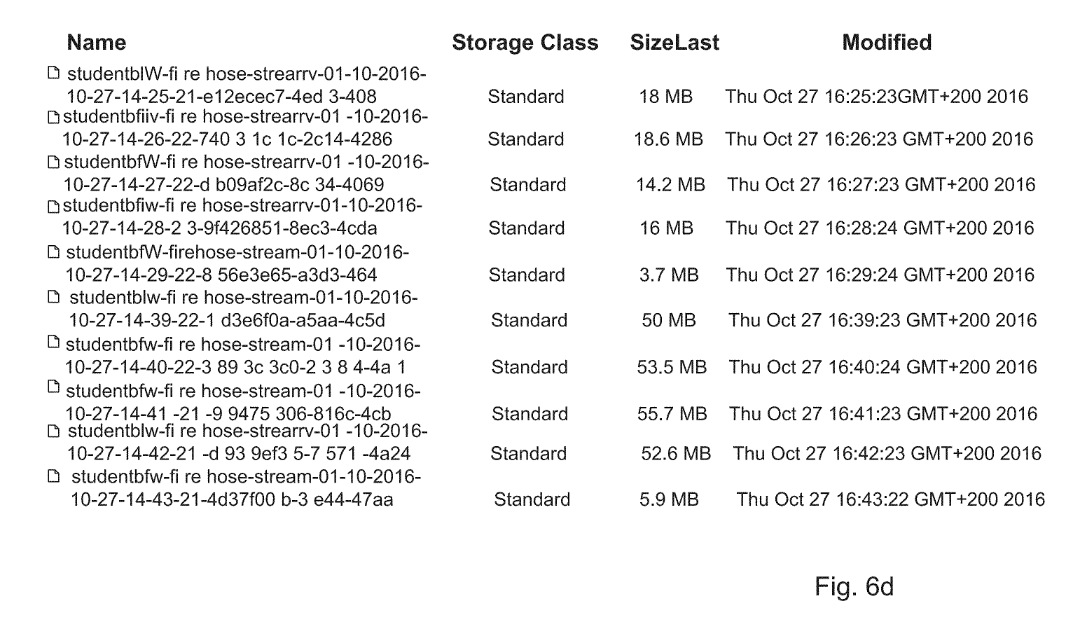

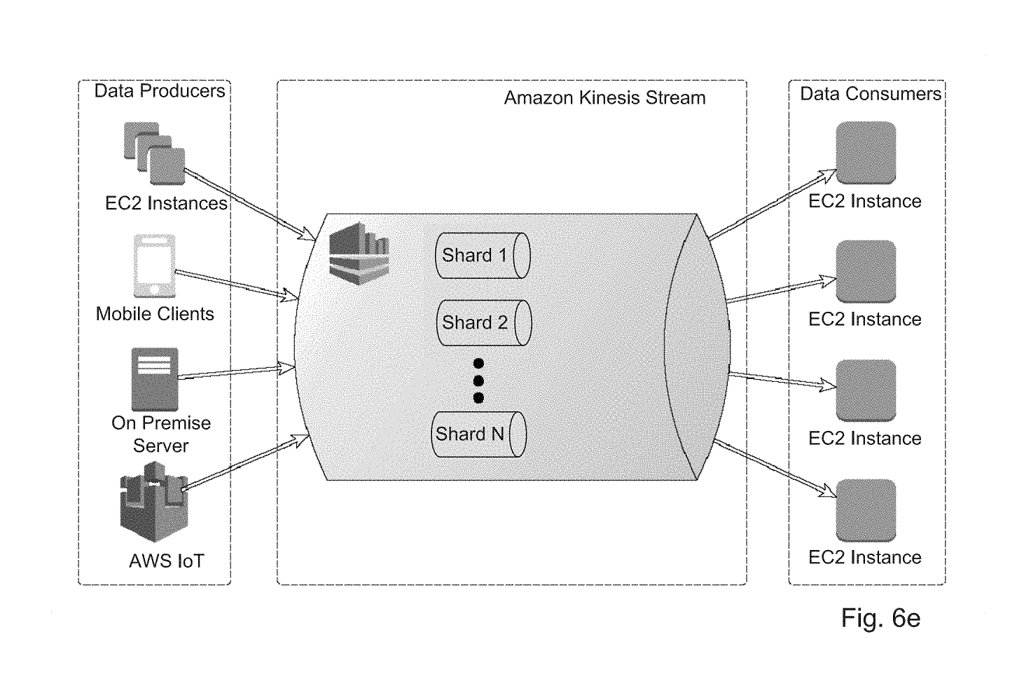

FIG. 6a illustrates an overview of AWS IoT service platform;

FIG. 6b illustrates basic control flow between SWF service, decider and activity workers;

FIG. 6c illustrates a screenshot of AWS Data Pipeline Architecture;

FIG. 6d illustrates a S3 bucket with folder structure and data as delivered by Kinesis Firehose;

FIG. 6e illustrates an Amazon Kinesis stream high-level architecture;

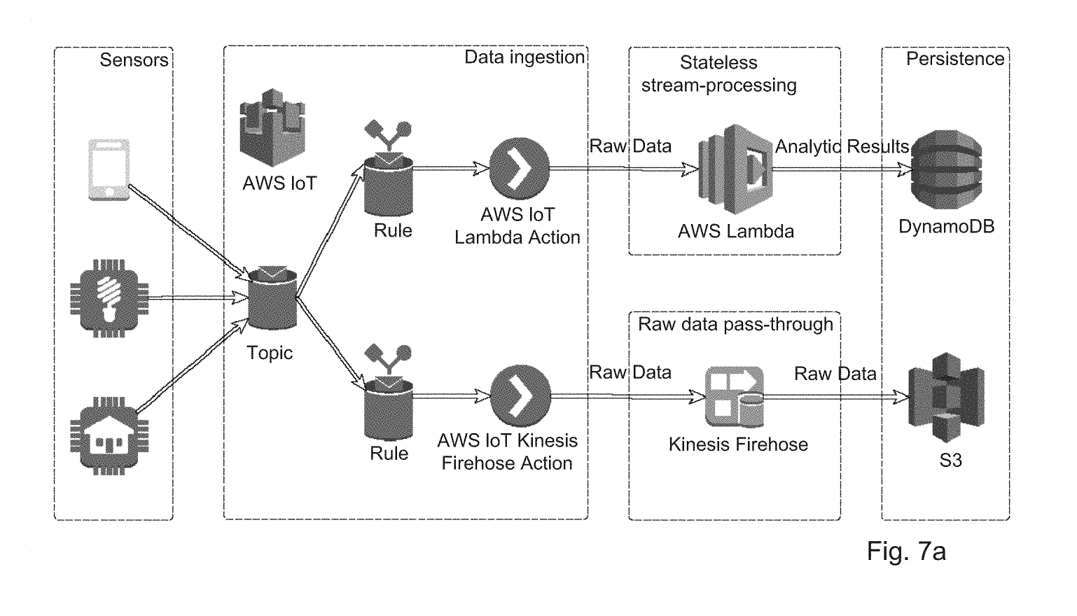

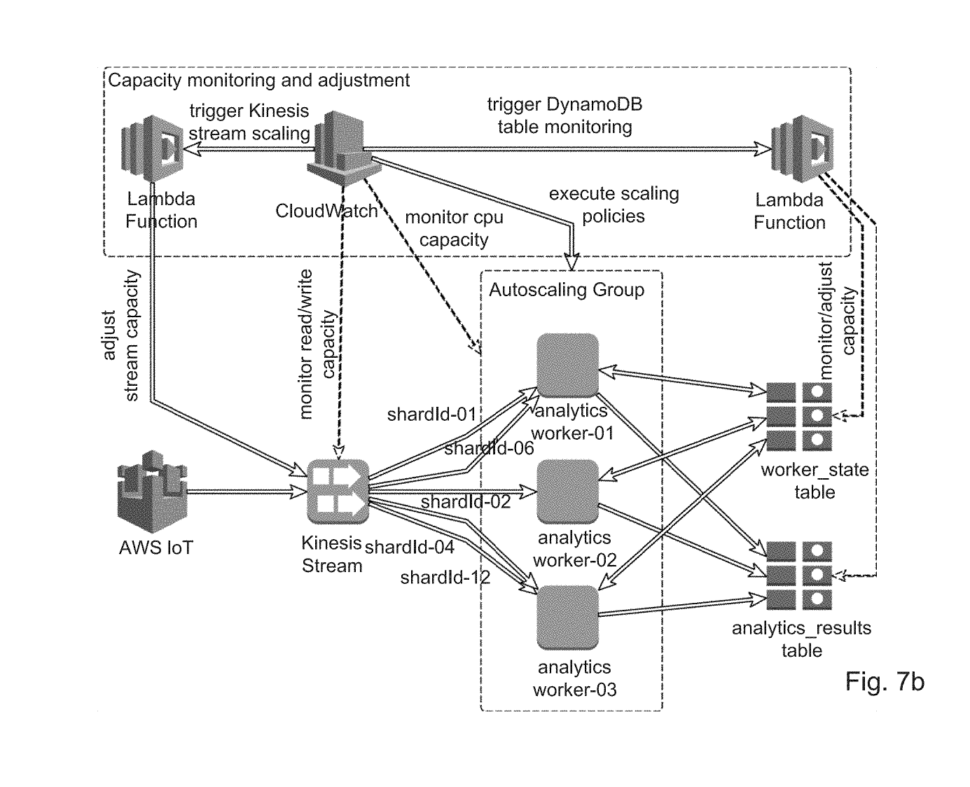

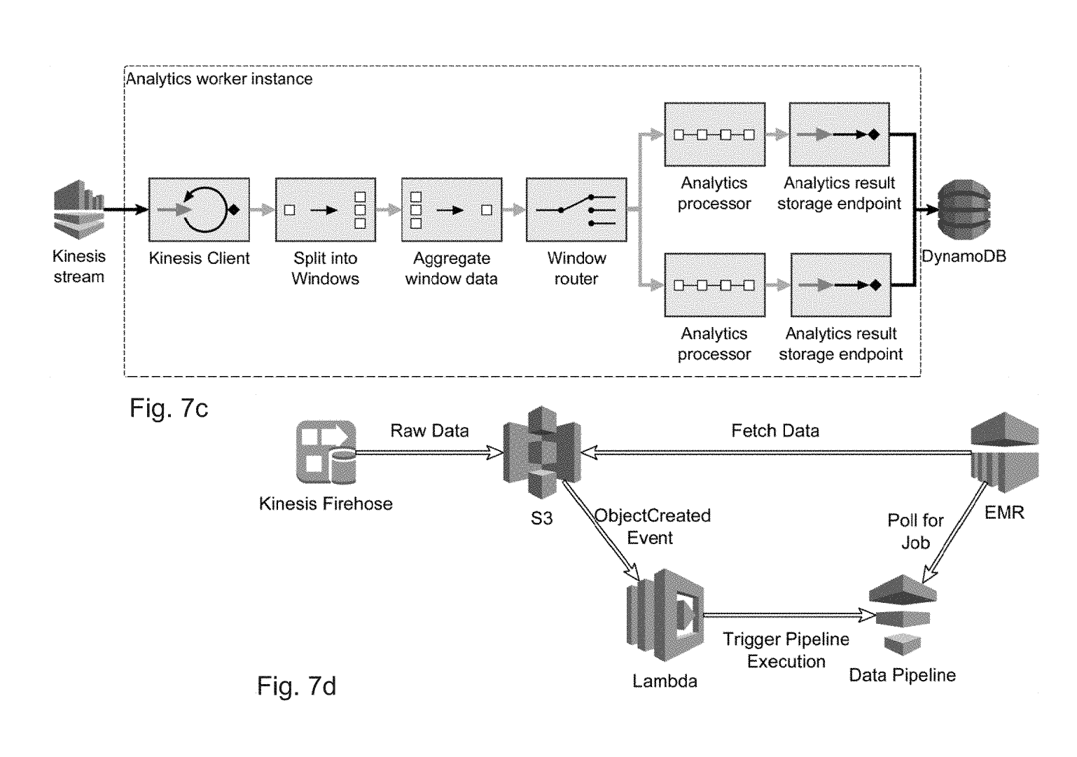

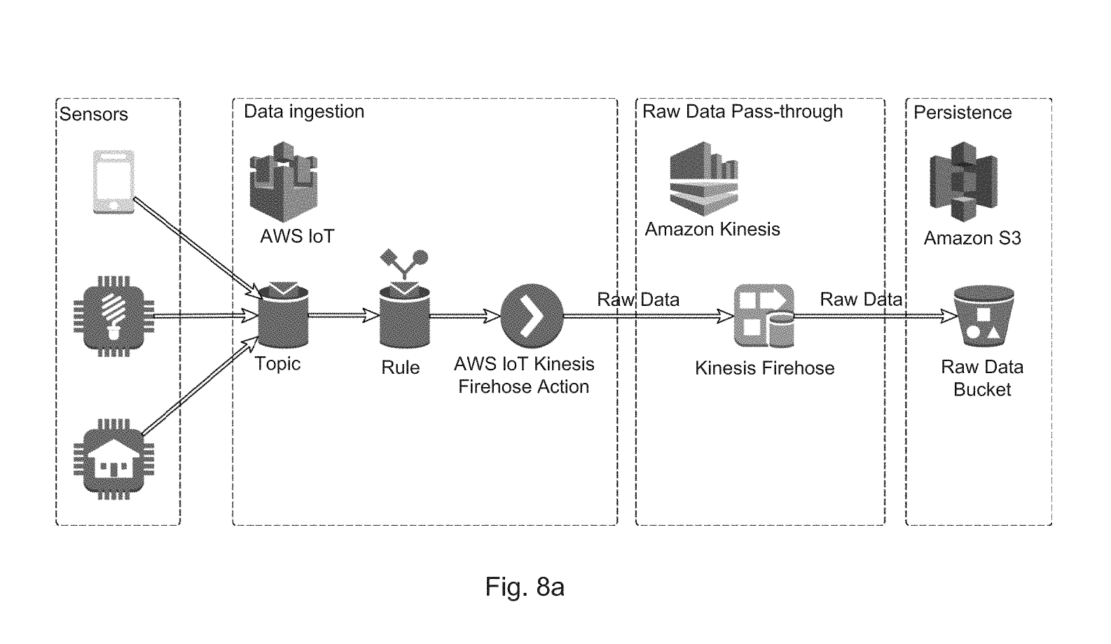

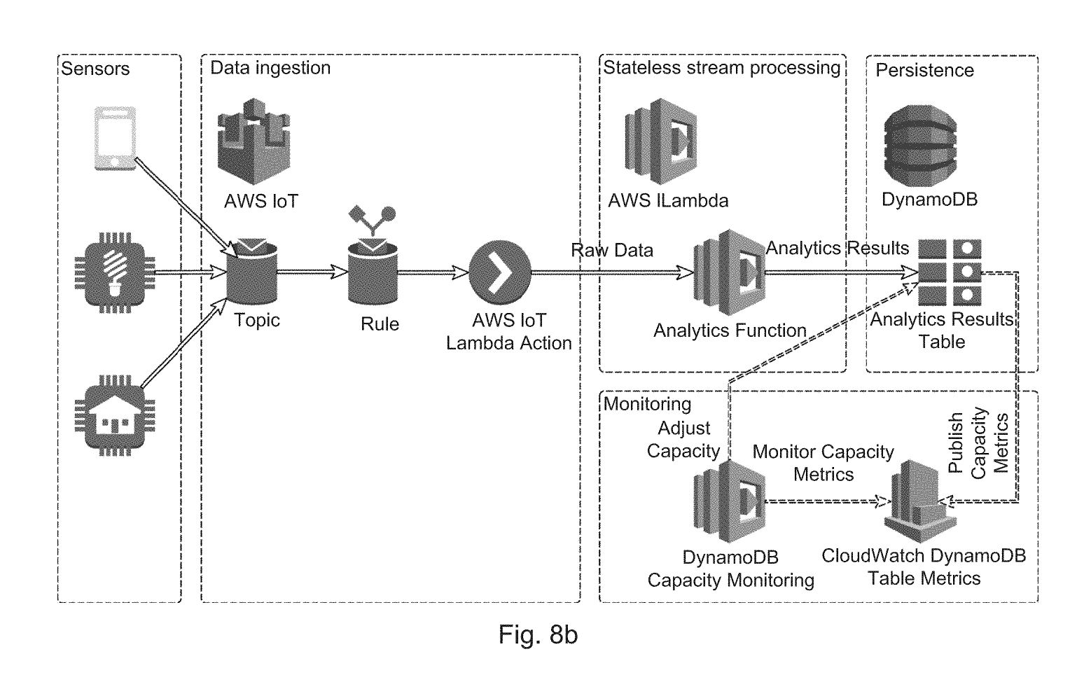

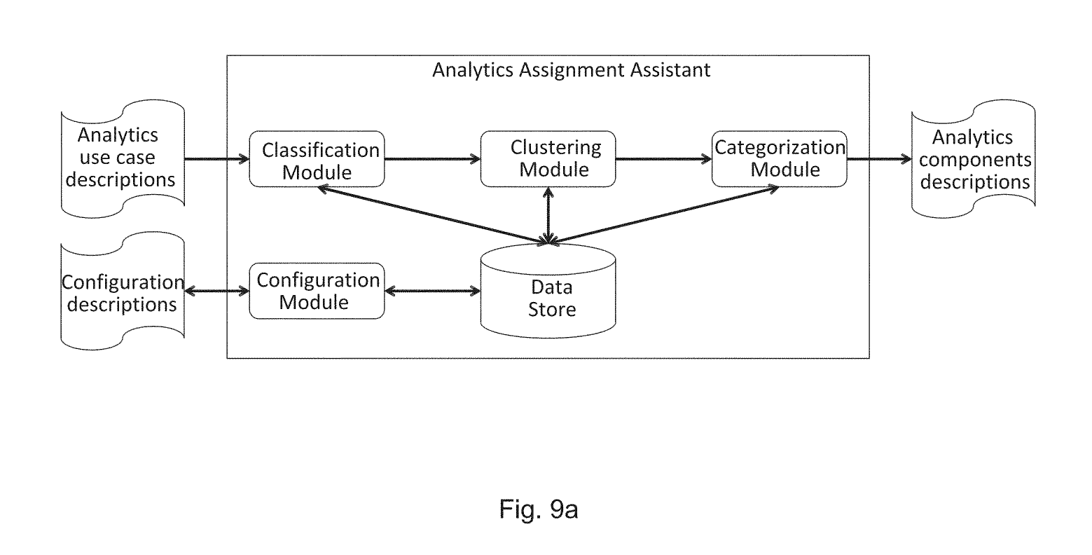

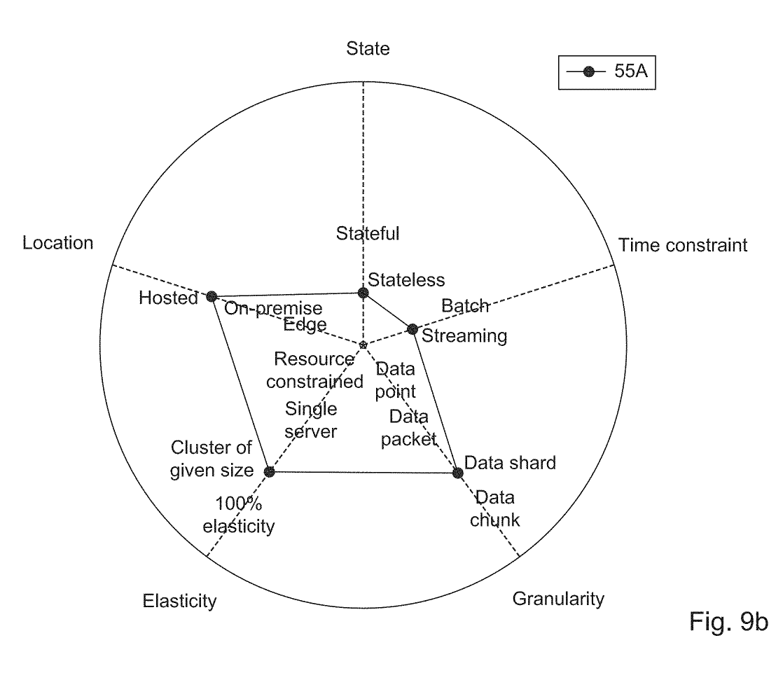

FIG. 7a illustrates a platform with stateless stream processing and raw data pass-through lane;

FIG. 7b illustrates an overview of a stateful stream processing lane;

FIG. 7c illustrates a schematic view of a Camel route implementing an analytics workflow;

FIG. 7d illustrates a batch processing lane using on demand activated pipelines;

FIGS. 8a, 8b are respective self-explanatory variations on the two-lane embodiment of FIG. 7a (raw data passthrough and stateless online analytics lanes respectively).

FIG. 9a is a simplified block diagram of an Analytics Assignment Assistant system in accordance with certain embodiments.

FIG. 9b is a diagram useful in understanding certain embodiments of the present invention.

Methods and systems included in the scope of the present invention may include some (e.g. any suitable subset) or all of the functional blocks shown in the specifically illustrated implementations by way of example, in any suitable order e.g. as shown.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software, firmware, hardware or any combination thereof. Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case some or all of the variables, parameters, and computations described herein may be in hardware.

Any module or functionality described herein may comprise a suitably configured hardware component or circuitry e.g. processor circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application if and as appropriate and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

The process of generating insights from Internet of Things (IoT) data, often referred to with the buzzwords IoT and Big Data Analytics, is one of the most important growth markets in the information technology sector [78]; it is appreciated that square-bracketed numbers herewithin refer to teachings known in the art which according to certain embodiments may be used in conjunction with the present invention as indicated, where the respective teachings is known inter alia from the like-numbered respective publication cited in the Background section above. The importance of data as a future commodity is growing [73]. All major cloud service providers offer products and services to process and analyze data in the cloud.

FIG. 9a is a simplified block diagram of an Analytics Assignment Assistant system which may be characterized by all or any subset of the following:
The input to the system of FIG. 9a typically includes a formal description of analytics use cases to be executed. These descriptions typically include the modules' requirements along certain dimensions e.g. as described below.
The Classification Module classifies the current set of analytics use cases regarding the given dimensions. For this purpose it uses a multidimensional manifold providing data, state, time, location, and elasticity axis.
The Clustering Module joins related analytics use cases according to their classification.
The Categorization Module deducts suitable execution environments for given clusters, not necessarily 1-to-1 e.g. there may be less execution environments than clusters.
The configuration descriptions specify the system configuration e.g. of an analytics platform and may include description of available execution environments.
The Configuration Module handles the configuration of the system.
The Data Store holds persistent data of the system, including some or all of: the set of analytics use cases, the available execution environments, other configuration and intermediate data produced e.g. by any one of the modules of FIG. 9a. All modules have access to the data.
The output of the system includes a formal description of the mapping of the analytics uses cases to the execution environments.

The inputs to the system of FIG. 9a may include formal descriptions, using a predefined syntax, of analytics use cases and of configurations which are accepted via a given interface such as but not limited to a SOAP or REST interface or API. Any suitable source (e.g. a user via a dedicated GUI or by another service) may feed the interface from the outside using the predetermined format or syntax. The configuration descriptions typically each describe an execution environment which is available to, say, an IoT or other platform on which the (IoT) analytics (or other) use-cases are to be executed. Inputs are supplied to the system at any suitable occasion e.g. once an hour or once a day or once a week or less or sporadically. For safety reasons, no new input is typically accepted until a current output has been produced, based on existing input.

Typically, the configuration descriptions entering the assistant system of FIG. 9a, aka Analytics Assignment Assistant (AAA), formally describe configurations which configure the Analytics Assignment Assistant (AAA). These configurations may include information on existing or potential execution environments on other platforms. Mappings generated by the AAA may be used not only to deploy analytics use cases into the correct environments, but also to setup these environments at the outset.

The output of the system of FIG. 9a may include an “analytics components descriptions” (aka analytics mappings) e.g. execution environment per cluster. By default, the output may go to the instance that provided the input.

The method of operation of the system of FIG. 9a may for example include some or all of the following operations, suitably ordered e.g. as shown:

1. Receive input to the system which typically includes a formal description of analytics use cases to be executed. These descriptions may include module requirements along defined dimensions e.g. some or all of those described here within. Configuration descriptions typically specify system configuration e.g. of an analytics platform and may include the description of the available execution environments.

2. The Classification Module classifies the current set of analytics use cases regarding the given dimensions, typically using a multidimensional manifold providing plural (e.g. data, state, time, location, and elasticity) axes e.g. as shown in FIG. 9b.

3. The Clustering Module joins related analytics use cases according to their classification.

4. The Categorization Module deduces suitable execution environments for given clusters, not necessarily in a 1-to-1 way, i.e. there may be less execution environments than clusters.

5. The Configuration Module handles the configuration of the system. The Data Store holds persistent data of the system, including the set of analytics use cases, the available execution environments, other configuration and intermediate data produced by one of the modules of FIG. 9a. All modules typically have access to the data.

Generated system output typically includes a formal description of the mapping of the analytics uses cases to the execution environments.

The classification module typically classifies use-cases along each of, say, 5 dimensions. Typically a “current set” of use-cases is so classified, which includes a working list of use cases to be classified which may originate as an input and/or from the data store. The input to FIG. 9a's classification module may include any formal description of analytics use cases to be executed. These descriptions typically include the requirements of the modules of FIG. 9a, along the defined dimensions. The classification module (and other modules) can of course also receive further input from the data store. Typically, the description includes values along all 5 dimensions, for relevant use case/s, or a mapping may be stored in the data store, that maps use cases to values along the respective dimensions. Alternatively or in addition, a human user may be consulted, e.g. interactively, to gather values along all dimensions and typically store same for future use e.g. in the data store of FIG. 9a.

Typically, execution environments are described using the same dimensions as analytics use cases and/or clusters thereof. If dimensions of an execution environment exactly match (=) those of a cluster, there may be an assignment of the use-case to that environment. Assignment of clusters to execution environments may also occur if the dimensions of the execution environment are “bigger” or greater than that of the cluster e.g. if the clusters dimensions all “fit into” (<=) the environment's dimensions e.g. stateless fits into stateful, cluster fits into elastic, data point fits into data shard or more generally, in FIG. 9b a cluster fits into an environment if the closed line of the cluster lies within the closed line of the environment. The configuration may however stipulate rules or limits, restricting the extent to which such cluster or use-cases are “allowed” to be executed by larger environments. It is appreciated that a may fit into b and b may fit into a e.g. since batching can be simulated with streaming but streaming can also be simulated with batching, there is a fit in both directions (a batching use-case fits into a streaming environment but a streaming use-case also fits into a batching environment).

Typically, clustering includes putting all use cases having the same values for the same dimensions into a single cluster such that use cases go in the same cluster if and only if their values along all dimensions are the same. If use cases have different values along at least one dimension, those use-cases belong to different clusters. For example, in FIG. 9b, each use case is drawn as a closed line/curve. If the lines of two use cases completely overlap, they belong to the same cluster. Otherwise, the two use-cases belong to different clusters.

The data stored in the data store is typically accessible by all modules in FIG. 9a. Each data type may for example be stored in a dedicated table with three columns: ID, Data and Link where ID is a unique identifier of each row in the table. Data is the actual data to be stored, and Link is a reference to another row that can also be in another table. However, the data store need not to provide tables at all and may instead (or in addition) include a key value store, document store, or any other conventional data storing technology. A mapping may be stored in the data store that maps known clusters to known environments; this mapping may be pre-loaded or may be generated interactively by consulting the user in an interactive way, gathering the mappings and storing them for future use.

The “configuration module” in FIG. 9a typically manages the configuration including accepting configuration data as input, storing same in the data store, retrieving configuration from the data store and providing the configuration as output. The actual format in which the configuration is stored is not relevant, as long as all modules are aware of it, or compatible with it. Other possible configurations may refers to categorization e.g. whether data points are permitted to be processed in a data packet environment or not, whether it is permitted to execute stateless use-cases in stateful environments, and so forth. Other configurations may be enabling or disabling or forcing (e.g. for feedback) of user interaction. Configurations change the system's behavior and may include any changeable parameters to the system e.g. platform (except data input/data output), as opposed to hard coded parameters of the system which are not changeable.

Still referring to FIG. 9a, all or any subset of whose modules may be provided in practice, it is appreciated that descriptions of use-cases and configurations that the assistant of FIG. 1 receives may each be defined formally in any suitable syntax known to the assistant and to systems interacting therewith, if and as needed. For example, if the output of the assistant is provided to an IoT analytics platform, the syntax may be pre-defined commonly to both the assistant and the IoT analytics platform.

Possible syntaxes for each (for each use-case and for each environment configuration and later, for the assistant output) include the following. Capitalized terms in the syntaxes below are to be substituted by respective values for each analytics use case, as is evident from the example which follows each definition.

One possible syntax for describing each Analytics use case may include some or all of the following:

{

| | |
|---|---|
| “id” | : ANALYTICS USE CASE ID, |
| “name” | : ANALYTICS USE CASE NAME, |

“dimensions” : {

| | |
|---|---|
| “granularity” | : GRANULARITY VALUE, |
| “timeconstraint” | : TIME CONSTRAINT VALUE, |

| | |
|---|---|
| “state” | : STATE VALUE, |

| | |
|---|---|
| “location” | : LOCATION VALUE, |
| “elasticity” | : ELASTICITS VALUE |

}

}

Example (with extension):

| { | |
|---|---|
| “id” | : “ABC”, |
| “name” | : “My example analytics use case”, |

“dimensions” : {

| | |
|---|---|
| “granularity” | : “Data point”, |
| “timeconstraint” | : “Batch”, |

| | |
|---|---|
| “state” | : “Stateful”, |
| “location” | : “On premise”, |
| “elasticity” | : “Single Server” |

},
“dependencies” : [

{“dependency” : “DEF”},
{“dependency” : “XYZ”}

]

}

One possible syntax for describing each configuration (aka environment configuration) may include some or all of the following:

{

| | |
|---|---|
| “id” | : CONFIGURATION ID, |
| “name” | : CONFIGURATION NAME, |
| “execenvs” | : [{ |

| | |
|---|---|
| “id” | : CAPABILITY ID, |

| | |
|---|---|
| “name” | : CAPABILITY NAME, |

“dimensions” : {

| | |
|---|---|
| “granularity” | : GRANULARITY VALUE, |
| “timeconstraint” | : TIME CONSTRAINT VALUE, |

| | |
|---|---|
| “state” | : STATE VALUE, |

| | |
|---|---|
| “location” | : LOCATION VALUE, |
| “elasticity” | : ELASTICITS VALUE |

}

}],
“categorization” : CATEGORIZATION VALUE,
“userinteraction” : USER INTERACTION VALUE

}

Example (with extension):

| { | |
|---|---|
| “id” | : “123”, |
| “name” | : “My example config”, |
| “execenvs” | : [{ |

| | |
|---|---|
| “id” | : “666”, |

| | |
|---|---|
| “name” | : “foo bar”, |

“dimensions” : {

| | |
|---|---|
| “granularity” | : “Data point”, |
| “timeconstraint” | : “Batch”, |

| | |
|---|---|
| “state” | : “Stateful”, |

| | |
|---|---|
| “location” | : “On premise”, |
| “elasticity” | : “Single Server” |

}

},{

| | |
|---|---|
| “id” | : “777”, |

| | |
|---|---|
| “name” | : “bar foo”, |

“dimensions” : {

| | |
|---|---|
| “granularity” | : “Data shard”, |
| “timeconstraint” | : “Batch”, |

| | |
|---|---|
| “state” | : “Stateless”, |

| | |
|---|---|
| “location” | : “On premise”, |
| “elasticity” | : “Single Server” |

}

}],
“categorization” : “downwards”,
“userinteraction” : “none”,
“mynewconfig” : “all off”,
“myotherconfig” : “all on”

}

The “analytics components descriptions” (aka “Analytics mappings”) output of the assistant of FIG. 9a (e.g. the output of the categorization module) typically includes the execution environment assigned per cluster and/or per analytics use-case. For example, both options may be provided, e.g. per analytics use case as a default and per cluster as a selectable option. The output may or may not, as per the configuration of the assistant of FIG. 9a, include any information about, or mention of clusters, although existence of a cluster may typically be derived in an event of assignments of several analytics (because they belong to a single cluster) to the same execution environment. The output of the assistant may also include additional information, such as whether the match between use-case and environment is an exact or only an approximate match e.g. in cases of stateless analytics occurring in stateful environments as described herein. Other information may be added as well, e.g. which dimensions are an exact match (e.g. use-case and environment have the same values along all dimensions) and which ones are approximated.

A possible syntax for the output of the assistant of FIG. 9a may include some or all of the following:

| { | |
|---|---|
| “id” | : MAPPING ID, |
| “name” | : MAPPING NAME, |

| | |
|---|---|
| “mappings” | : [{ |

| “analyticsusecaseid” : ANALYTICS USE CASE ID, | |
|---|---|
| “execenvid” | : EXECUTION ENVIRONMENT ID |

}]
}

Example:

| { | |
|---|---|
| “id” | : “1A2”, |
| “name” | : “My mapping”, |

| | |
|---|---|
| “mappings” | : [{ |

| “analyticsusecaseid” : “KLM”, | |
|---|---|
| “execenvid” | : “555” |

},{

| “analyticsusecaseid” : “NOP”, | |
|---|---|
| “execenvid” | : “444” |

}]
}

The above 3 possible syntaxes, provided merely by way of example, are all expressed for convenience in JSON, although this is not intended to be limiting. The specific JSON format provided herein for analytics use case descriptions, configuration descriptions and analytics component descriptions is merely by way of example. JSON format (or any suitable alternative) may be used to formally describe a scenario, similarly.

It is appreciated that in the above syntaxes, ID and NAME are arbitrary alpha-numeric strings. The dimension values may be those defined herein e.g. GRANULARITY VALUE may be one of (data point, data packet, data shard, data chunk). The syntax and possible values are both extendable, e.g. the set of possible values may be conveniently augmented or reduced and dimensions may easily be added or removed. Fields may also conveniently be added or removed, e.g. add a top level field. “Dependencies” may be added which points to other analytics use cases. Features and tweaks which accompany the JSON format may be allowed, e.g. use of arrays using square brackets or [ ]. Embodiments of the invention seek to assign analytics use cases to execution environments. The above syntaxes are merely examples of the many possible input and output formats.

Any suitable mode of cooperation may be programmed, or even provided manually, between the assistant of FIG. 9a and between the IoT analytics platform receiving outputs from the assistant of FIG. 9a. The platform may have a stream of job executions to handle. A job may be a concrete execution of an analytics use case, i.e. run an activity recognition component on the newest 30 seconds of data of this data set every 10 seconds. When a job is first submitted, the assistant would be consulted, and output where (which lane of the platform) to execute this job based on the use case. This could be a manual or (semi-)automatic step. Afterwards all further jobs of this type (e.g. based on the same use-case, belonging to the same cluster) may be executed in the same way, obviating any need to consult the assistant again, unless and until requirements change. Thus, for example, there is no need to consult the assistant for each execution of a job. A job may be static and run for years, whereas each execution in the stream may take only seconds, and may slightly change frequently (each execution e.g.).

Any suitable method may be employed to allow use-case x to be positioned along each of the plural e.g. 5 dimensions. For example, the description may already contain the values for all 5 dimensions. Or, there may be a mapping in the data store of FIG. 9a, which is operative to map a given use case to the respective dimensions. Alternatively or additionally, the user may be interactively consulted by the system, gathering info and storing same for future use. For example, there may be a mapping in the data store that maps known clusters to known environments.

Practically speaking, analytics use cases may be implemented by data scientists writing respective codes to implemented desired software functionalities e.g. IoT analytics respectively. Besides delivering this code, the data scientists may deliver a description of the code, e.g. inputs used by the code, outputs produced by the code, and runtime behavior of the code including the code's “values” along dimensions such as some or all of those shown and described herein. Alternatively or in addition, software functionality may be provided, and may communicate with the assistant of FIG. 9a via a suitable API to which the syntax above is known. This software functionality may take analytics code and suitable parameters as input and generates therefrom, as the software functionality's output, which may be provided to the assistant of FIG. 9a e.g. via the API, descriptions used by the assistant of FIG. 9a e.g. using the JSON syntax above, including e.g. values of the code along the dimensions. Alternatively or in addition, software functionality may be provided which generates description of execution environments including for each environment its values along the dimensions described herein. Or, software developers implementing various lanes also generate, manually, a formal description of the behavior of the respective lanes e.g. using the JSON syntax above. Such manual inputs may be provided to the assistant of FIG. 9a, by data scientists or developers, using any suitable user interface, which may, for example, display JSON code including blanks (indicated above in upper-case) that have to be filled in by the data scientists or developers (as indicated in the respective examples herein e.g. in which blanks indicated in upper-case are filled in). It is appreciated that often, data scientists and/or developers may be tasked with producing certain analytics with certain runtime behaviors or certain analytics lane/s that satisfy or guarantee certain conditions, such as certain values along certain of the dimensions described herein. In this case, the user interface of the data scientists and/or developers with the assistant of FIG. 9a may stipulate these requirements, even in natural language.

A particular advantage of certain embodiments is that assignment of certain analytics use cases to certain analytics lanes no longer needs to be done by a human matching use case requirements to lane or environment requirements. Instead, this matching is automated.

According to certain “set of predefined mappings for common use cases” embodiments, a table, built in advance manually, may be provided which stores a mapping of each of a finite number of use-cases along each of all 5 dimensions stored herein or a subset thereof. In this case, each new analytics use case may be accompanied by dedicated analytics written by data scientists who also provide, via a suitable user-interface e.g., the dimensions for storage in the table. Similarly, each new execution environment may be associated with the values of that environment, along some or all of the dimensions, provided by developers of the environment via a suitable user-interface and stored in the table.

One possible manual mapping is described herein for an example set of use cases which is not intended to be limiting. A data scientist developing analytics may specify requirements in terms of state and data. Time requirements typically stem from the concrete application of the analytics.

According to certain embodiments, each time the analytics platform gets an update, there is a trigger alerting data scientists and/or developers to consider updating manually the use-case descriptions and/or configuration descriptions respectively.

A particular advantage of the clustering module in FIG. 9a is facilitation of the ability to compare the merits of plural execution environments (there is typically a finite number of execution environments at any given time) for executing certain (clusters of) use-cases.

Clustering may be performed at any suitable time or on any suitable schedule or responsive to any suitable logic, e.g. each time the assistant of FIG. 9a is called.

It is appreciated that the “assistant” system of FIG. 9a is particularly useful for automatic deployment of execution environments for a platform, such as but not limited to an IoT analytics platform. Such platforms may serve various scenarios intermittently. In many platforms, the type of analytics that are to be deployed heavily depend on the scenario that the platform is serving. For example, a single platform might intermittently be serving a basketball game scenario which needs one kind of analytics or analytics use-case (e.g. jump detection) with certain real-time requirements (within 3 seconds). An industry scenario however needs another kind of analytics or analytics use-case (e.g. degradation detection) with other time requirements (e.g. within 2 hours). Then again the platform may find itself serving a basketball scenario or perhaps some other scenario entirely which needs still another kind of analytics or kind of analytics with still other requirements where requirements may be defined along, say, any or all of the dimensions shown in FIG. 9b. Assuming there is a source of data which is operative to schedule scenarios to be served by the platform, and a source of data which provides formal descriptions e.g. in JSON of scenarios, and a source of data which derives analytics use cases from formal description e.g. in JSON of scenarios, it is appreciated that the system of FIG. 9a allows execution environments to be automatically assigned to use cases, hence scenarios are automatically deployed by the platform.

It is appreciated that analytics use cases needed by a scenario are not always static. For example, there are scenarios, where the analytics use cases needed in a scenario e.g. the actual queries that are posted to the analytics platform during a basketball game scenario, depend on the current interaction with the analytics platform. Depending on whether a specific query is posted, an analytics use case may be deployed at runtime to answer the query and be un-deployed after runtime. A data source may be available which has derived which use cases need to be deployed/un-deployed at runtime.

According to certain embodiments, the “configuration descriptions” entering the assistant system of FIG. 9a, formally describe e.g. in JSON, a configuration for a platform and if the platform is so configured, the platform then provides, e.g. on demand, a certain execution environment such that each configuration description may define an execution environment for the platform.

Dimensions, some or all of which are provided in accordance with certain embodiments, some or all of which may be used by the Classification Module, are now described in further detail with reference inter alia to FIG. 2a: Granularity requirements for different types of analytics use cases, the table of FIG. 2b showing capabilities of a platform supporting 4 base classes according to certain embodiments, FIG. 3a: Dimensions of the computations performed for different use cases and FIG. 3b: Vector representations of analytics use cases, and the spider diagram of FIG. 9b illustrating an Analytics capabilities example.

Dimensions may for example include granularity of computation e.g. for a given use-case. The granularity of a computation is defined by the data required for its performance. Possible values for the granularity of a computation may for example include some or all of:

Data point: may include a vector of measurements often from a single sensor. A computation has the granularity of a data point if no data outside of the data point is required for it with the exception of pre-established data such as an anomaly model.

Packet: A packet is a collection of data points. A computation has the granularity of a data packet if all data required for the computation is contained in the data packet with the exception of pre-established data such as an anomaly model.

Usually the data points inside a packet have the some relation, and often they are measurements from the same sensor.

Shard: A shard is a sequence of data packets and their associated analytics results. A computation has the granularity of a shard if only data contained in the shard is required for it. Computations performed on shards typically do not depend on data outside of the shard. Computations requiring multiple data packets or the results of previous computations from the same shard, are however allowed. A shard collects the data from a group of sensors with a commonality. A shard may contain past analytics results and current measurement data from sensors. For instance sensors associated with a single person or the data collected from the sensors monitoring a room in a house.

Chunk: A chunk is a subset of available raw data. No restrictions apply to computations on chunks of data. They can be arbitrarily complex and require as much raw measurement data and result data from as many sources as desired.

Typically, a data point is a single measurement from one machine e.g. sensor or processor co-located with a sensor, which typically includes a timestamp and one or multiple sensor values. Transformations, meta data enrichment and plausibility tests may be computed on data points. An incoming data point allows machine activity to be assumed (Activity detection) according to certain embodiments. Multiple data points form a data packet on which anomaly detection may be performed according to certain embodiments. On a data shard, energy peak prediction and degradation monitoring use cases may be performed, according to certain embodiments. Data chunks may originate from different machines or sensors.

According to certain embodiments, the following types of data (e.g. only the following types of data) make possible the following use cases respectively:

Activity detection is a use case possible for data points and/or anomaly detection is a use case possible for data packets and/or degradation monitoring and/or energy peak prediction are use cases possible for data shards.

FIG. 2a shows granularity requirements for different types of example analytics use cases. Entries marked x denote the typical data granularity required by the analytics use case family in that row.

Dimensions may for example include state of a computation. Computations are considered stateful if they retain a state across invocations. As a consequence, repeating a stateful computation using the same inputs may yield different outcomes each time. In addition, a computation is also considered stateful if it requires more than the data contained in a single data packet to be performed. In this case the state is introduced by accumulating the data necessary to perform the computation. Possible values along this dimension may for example include some or all of:

Stateless: Computations that do not require previous results or additional data.

Stateful: Computations that require previous results or the accumulation of data.

Typically, calling a stateless function multiple times, with the same input data, always leads to the same result, whereas stateful computations use at least one computation result from at least one previous invocation, hence 2 or n invocations (or function calls) with the same input data, may lead to 2 different results in the 2 (or n) times the function is called.

Dimensions may for example include time constraint, the time it takes until the result of a computation e.g. performed in a use-case, is available. Computations can for example be classified as being performed in real-time or near-time on data streams or in larger intervals on batches of data. Possible values along this dimension may for example include some or all of:

Streaming: Computations that need to be completed in real-time or near real-time on streaming data.

Batch: Computations that are completed on fixed amounts of data and at larger intervals.

According to certain embodiments, a streaming state (as opposed to a batch state) makes the following use cases possible: Activity detection and/or Anomaly detection and/or Degradation monitoring and/or Energy peak prediction.

With reference for example to the clustering module of FIG. 9a, it is possible to express the previously presented analytics use cases in the form of vectors with the values of the vectors' respective vector components being selected from the ranges available for each dimension. FIG. 3a shows the use cases plotted in a coordinate system with the axes of the dimensions state, granularity and time constraint. The axis labeled ‘state’ indicates if state is required to perform the computation. The axis labeled ‘time constraint’ shows if the computation is performed on streaming data and should be completed in near-time or real-time or on batches of data. The axis labeled ‘granularity’ shows where the data required by the computation is drawn from. Using the cross product, it is appreciated that there are 4×2×2=16 different vectors, in the illustrated embodiment. Each vector represents a different possible type of computation. From here on the computations may be described by these vectors as classes. From the graph it can be derived that only a few classes out of the total possible classes are actually used. The ones that have representatives in the plot are given by the vectors in FIG. 3b.

Analytics platform capabilities are now described with reference for example to the Categorization Module of FIG. 9a. For a platform that can support all of the given use cases it is therefore sufficient to support the four classes of computations introduced above. However it can be shown that by enabling these four classes, the platform actually supports more than just the computations explicitly stated. FIG. 2b shows which additional classes of computations can be performed. To minimize the size of the table, the classes containing data points and data packets have been combined into a single column. A check mark indicates that this class of computations is either supported by the platform directly, or that the class is supported by implication, e.g. it can be reasoned that a computation environment supporting stateful computations can support stateless computations just as well. A stateless computation can be viewed as one where the state is constant between computations.

Under the assumption that the necessary scripts or services are provided to push the data into the system, having the capability to perform stream processing implies the capability to do batch processing as well.

Dashes indicate that these classes of computations are not supported by the platform. However, this does not necessarily mean it is entirely impossible to perform this type of computation. In most cases it is possible to arrive at a suitable solution by moving the computation further to the right in the table. As an example, there is no check mark in the table for performing stateful computations on data packets. But it is still possible to do these computations by simply interpreting a data packet as a data shard containing only a single data packet. Timing constraints or other factors may forbid going into this direction. In such a case, the platform must be extended with a fast and persistent state store to support this new class of computations.

Analytics Clusters according to other embodiments are now further described with further reference for example to the Clustering Module of FIG. 9a. It is possible to express the previously presented analytics use cases in the form of vectors with the values of their respective vector components being selected from the ranges available for each dimension. FIG. 9b shows an example use case plotting, in a spider diagram the axes of the dimensions state, granularity, time constraint, location and elasticity.

Referring now to FIG. 9b, it is appreciated that some or all of the values shown by way of example may be provided along the respective dimensions, some or all of which may be provided. The “Elasticity” and “Location” dimensions are now described in detail. These are particularly useful inter alia for formally describing properties or capabilities for a scalable SSA (small scale analytics) application.

elasticity of an application specifies if the application e.g. environment or use-case is capable of automatic scaling responsive to changing workload. Along the elasticity dimension, some or all of the following values may be provided:

a. Resource constrained: If resource constrained, an application is executable on a single machine, fixed to preset resources and incapable of scaling.

b. Single server: Application executed on a single server instance, capable of variable resource usage but not capable of scaling.

c. Cluster of given size: Application can automatically scale with changing workload but only subject to a given limitation on cluster size. Cluster resources are typically used only if needed and may have to be paid for. This occurs for example in a system which scales resources depending on the number and/or complexity of incoming requests to the system. Existing software can then be adapted to add new instances whenever the workload increases, and typically such instances are automatically removed e.g. upon a minimum size if the workload decreases. For providing the execution environment and at the same time retaining cost effectiveness, this behavior may also be applied to a computation cluster.

d. 100% elasticity: Application able to scale according to the workload and automatically adds or removes server instances to the underlying cluster. Enables optimal resource usage and, typically, lowest costs at highest utilization.

The ordinality may be that value a above along the elasticity dimension is less than b which is less than c which is less than d.

An application's Location describes the place where the application is executed. Along the location dimension, some or all of the following values may be provided:

a. Edge: Application executed on device directly attached to the machine, e.g. an Intel NUC, Raspberry.

b. On-premise: Execution on a workstation, self-hosted server or cluster.

c. Hosted: Application is executed on a service provider's infrastructure.

The ordinality may be that value a above along the location dimension is less than b which is less than c.

Still referring to FIG. 9b, it is appreciated that one characterization along a dimension D is “greater than” another, if it is shown further from the origin (the intersection point of the 5 illustrated dimension). For example, along the “state” dimension, stateful is greater than stateless hence a stateful environment can execute a stateless use case, but not vice versa. Along the granularity dimension, data shard is greater than data packet, along the elasticity dimension, “100% elasticity” is greater than “single server”, etc.

It is appreciated that a system's (e.g. platform's) configurations may not only include an execution environment. Configurations may include any changeable parameters (except data input/data output) to a given deployed system e.g. platform. Whatever is not configurable (or data in/out) is hard coded. A deployed system's “configuration” may also refer to the capability of the deployed system to execute analytics with certain given requirements, such as, but not limited to, some or all of: working on data points or data streams, providing real-time execution or not, being stateful or not, being elastic or not, including definitions along the dimensions defined herein. Other possible configurations refers to categorization; generally, execution environments may be described using the same dimensions as the analytics use cases and the resulting clusters. If the dimension of an execution environment matches or fits or equals those of a cluster, this may be the assignment. Or, clusters may be assigned to execution environments, if the values of the execution environment along the dimensions, are larger than that of the cluster. Typically, smaller analytics may run in somewhat larger environments, but particularly when the environment is much larger than the analytics, other constraints (e.g. cost) are typically considered.

Configurations may also include enabling or disabling or forcing user interaction with the deployed system; this may, if desired, be defined as a dimension of either analytics use case or execution environment, or both. It is possible to interact with the user if the system cannot determine a solution on its own, or to fill the data store with information. This possibility may be allowed for a system that has a user, and may be disabled if there is no user, e.g. in an isolated embedded system. Alternatively or in addition, user interaction may be forced in a training mode, and/or may be disabled e.g. in a production mode.

Teachings which may be suitably combined with any of the above embodiments, are now described.

According to certain embodiments, an auto scalable analytics platform is implemented for a selected number of common IoT analytics use cases in the AWS cloud by following a serverless first approach.

First, a number of prevalent analytics use cases are examined with regard to their typical requirements. Based on common requirements, categories are established and a platform architecture with lanes tailored to the requirements of the categories is designed. Following this step, services and technologies are evaluated to assess their suitability for implementing the platform in an auto scalable fashion. Based on the insights of the evaluation, the platform can then be implemented using, automatically, scaling services managed by the cloud provider where it is feasible.

Implementing an auto scalable analytics platform can be achieved with ease for analytics use cases that do not require state by selecting auto scaling services as its components. In order to support analytics uses cases that require state, provisioning of servers can be performed.

Analytics platforms can be used to gather and process Internet of Things (IoT) data during various public events like music concerts, sports events or fashion shows. During these events, a constant stream of data is gathered from a fixed number of sensors deployed on the event's premises. In addition, a greatly varying amount of data is gathered from sensors the attendees bring to the event. Data is collected by apps installed on the mobile phones of the attendees, smart wrist bands and other smart devices worn by people at the event. The collected data is then sent to the cloud for analytics. As these smart devices become even more common, the volume of data gathered from these can vastly outgrow the volume of data collected from fixed sensors.

Besides the described fluctuations in the amount of data gathered during a single event, there are also significant differences between the load generated by different events, and different types of events.

Experience with past events has shown that some of the components of the current analytics platforms have limitations regarding their ability to scale automatically. One solution has been to over-provision capacity. The new platform is typically able to adapt to changing conditions over the course of an event as well as conditions outside events and at different events automatically. This is becoming even more important as plans for future ventures call for the ability to scale the platform well beyond hundreds of thousands into the range of millions of connected devices.

Certain embodiments seek to provide auto scalability when scaling up as well as when scaling down e.g. using self-scaling services managed by the cloud provider to help avoid over provisioning, while at the same time supporting automatic scaling. Infrastructure configuration, as well as scaling behavior, can be expressed as code where possible to simplify setup procedures and preferably consolidate infrastructure as well.

The platform as a whole currently supports data gathering as well as analytics and results serving. The platform can be deployed in the Amazon AWS cloud (https://aws.amazon.com/).

The existing analytics platform is based on a variety of home-grown services which are deployed on virtual machines. Scalability is mostly achieved by spinning up clones of the system on more machines using EC2 auto scaling groups. Besides EC2, the platform already uses a few other basic AWS services such as S3 and Kinesis.

Presented here are a number of use cases that are representative of past usages of the existing analytics platform. The type of analytics performed to implement the use cases are then analyzed to find commonalities and differences in their requirements to take these into consideration.

3.1 Analytics Use Case Descriptions

The platform can be able to meet the requirements of the following selection of common uses cases from past projects and be open to new ones.

3.1.1 Data Transformation

Transformations include converting data values or changing the format. An example of a format conversion is rewriting an array of measurement values as individual items for storage in a data base. Another type of conversion that might be applied is to convert the unit of measurement values, i.e. from inches to centimeters, or from Celsius to Fahrenheit.

3.1.2 Meta Data Enrichment

Sensors usually only transmit whatever data they gather to the platform. However, data on the deployment of the sensor sending the data, might also be relevant to analytics. This applies even more to mobile sensors which mostly do not remain stay at the same location over the course of the complete event. In case of wrist bands they might also not be worn by the same person all the time. Meta data on where and when data was gathered, may therefore be valuable. Especially when dealing with wearables it is useful to know the context in which the data was gathered. This includes the event at which the data was gathered, but also the role of the user from whom the data was gathered, e.g. a referee or player at a sports event, a performer at a concert, or an audience member.

In order to perform meaningful analytics, metadata can either be added directly to the collected data, or by reference.

3.1.3 Filtering

An example of filtering is checking if a value exceeds a certain threshold or conforms to a certain format. Simple checks only validate syntactic correctness. More evolved variants might try to determine if the data is plausible by checking it against a previously established model, attempting to validate semantic correctness. Usually any data failing the check can be filtered out. This does not necessarily mean the data is discarded; instead the data may require special additional treatment before it can be processed further.

3.1.4 Simple Analytics

When performing anomaly detection, the data is compared against a model that represents the normal data. If the data deviates from the model's definition of normal, it is considered an anomaly.

This differs from the previously described filtering use case because in this case the data is actually valid. However, anomalies typically still warrant special treatment because they can be an early indicator that there is or that there might be a problem with the machine, person or whatever is monitored by the sensor.

3.1.5 Preliminary Results and Previews

Sometimes it is desired to supply preliminary results or previews e.g. by performing a less accurate but computationally cheaper analytics on all data or by processing only a subset of the available data before a more complete analytics result can be provided later.

Generally the manner in which a meaningful subset of the data can be obtained depends on the analytics. One possible method is to process data at a lower frequency than it is sampled by a sensor. Another method is to use only the data from some of the sensors as a stand-in for the whole setup. Based on these preliminary results, commentators or spectators of live events can be supplied with approximate results immediately.

Preliminary analytics can also determine that the quality of the data is too low to gain any valuable insights, and running the full set of analytics might not be worthwhile.

3.1.6 Advanced Analytics

Here presented are analytics designed to detect more advanced concepts. Examples may include analytics that are able not only to determine that people are moving their hands or their bodies, but that are instead able to detect that people are actually applauding or dancing.

For example, current activity recognition solution performs analytics of video and audio signals on premises. These lower level results are then sent to the cloud. There, the audio and video analytics results for a fixed amount of time are collected. The collected results sent by the on-premises installation and the result of the previous activity recognition run performed in the cloud, are part of the input for the next activity recognition run.

3.1.7 Experimental Analytics

This encompasses any kind of analytics that might be performed by researchers whenever new things are tested. Usually these analytics are run against historical raw data to compare the results of a new analytic or a new version of an analytic against the results of its predecessors.

3.1.8 Cross-Event Analytics

This use case subsumes all analytics performed using the data of multiple events. Typical applications include trend analytics to detect shifts in behavior or tastes between events of the same type or between event days. For example, most festival visitors loved the rap performances last year, but this year more people like heavy metal.

This also includes cross-correlation analytics to find correlations between the data gathered at two events, for example people that attend Formula One races might also like to buy the clothes presented at fashion shows.

Another important application is insight transfer, where, for example, the insights gained from performing analytics on the data of basketball games are applied to data gathered at football matches.

3.2 Analytics Dimensions

Even from short descriptions of given analytics use cases it may become apparent that there are differences between use-cases e.g. in the granularity of data required, the need to keep additional state data between computations and timing constraints extending from a need for real-time capabilities on the one hand, to batch processing historic data on the other hand.

3.3 Infrastructure Deployment

Usually an event is only a few days long. This means running the platform continuously may be inefficient.

Auto scaling can minimize the amount of deployed infrastructure. The reasons for this are that scaling has limits. While some services can scale to zero capacity, for others there is a lower bound greater than zero. Examples of such services in the AWS cloud are Amazon Kinesis and DynamoDB. In order to create a Kinesis stream or a DynamoDB table, a minimum capacity has to be allocated.

The platform can be created relatively shortly before the event and destroyed afterwards. Setting it up is preferably fully automated and may be completed in a matter of minutes.

Furthermore, it can be possible to deploy multiple instances of the platform concurrently e.g. one per region or one for each event, and dispose of them afterwards.

The Infrastructure as Code approach facilitates these objectives by promoting the use of definition files that can be committed to version control systems. As described in [74] this results in systems that are easily reproduced, disposable and consistent.

By using Infrastructure as Code there is no need to keep superfluous infrastructure because it can always be easily recreated. This also ensures that if a resource is destroyed, all associated resources are destroyed as well, except what has been designated to be kept e.g. data stores.

Architectural Design

Here presented is the architectural design of the platform, which can be developed based on the findings of the use case analysis.

5.1 Service and Technology Descriptions

AWS services which may be used are now described, including various services' features, and their ability to automatically scale up and down, as well their limitations.

5.1.1 AWS IoT

AWS IoT provides a service for smart things and IoT applications to communicate securely via virtual topics using a publish and subscribe pattern. It also incorporates a rules engine that provides integration with other AWS services.

To take advantage of AWS IoT's features, a message can be represented in JSON. This (as well as other requirements herein) is not a strict requirement; the service can work substantially with any data, and the rules engine can evaluate the content of JSON messages.

FIG. 6a, aka FIG. 5.1 shows a high-level view of the AWS IoT service and how devices, applications and other AWS services can use it to interact with each other. The following list gives short summaries for each of its key features. [43, 62]

Message broker The message broker enables secure communication via virtual topics that devices or applications can publish or subscribe to, using the MQTT protocol. The service also provides a REST interface that supports the publishing of messages.

Rules engine An SQL-like language allows the definition of rules which are evaluated against the content of messages. The language allows the selection of message parts as well as some message transformations, provided the message is represented in JSON. Other AWS services can be integrated with AWS IoT by associating actions with a rule. Whenever a rule matches, the actions are executed and the selected message parts are sent to the service. Notable services include DynamoDB, CloudWatch, ElasticSearch, Kinesis, Kinesis Firehose, S3 and Lambda. [44]

The rules engine can also leverage predictions from models in Amazon ML, a machine learning service. The machinelearningpredict_function is provided for this by the IoT-SQL dialect. [45]

Security and identity service All communication can be TLS encrypted. Authentication of devices is possible using X.509 certificates, AWS IAM or Amazon Cognito. Authorization is done by attaching policies to the certificate associated with a device. [46]

Thing registry The Thing registry allows the management of devices and the certificates associated therewith. It also allows to store up to three custom attributes for each registered device.

Thing shadow service Thing shadow service provides a persistent representation of a device in the cloud. Devices and applications can use the shadow to exchange information about the state of the device. Applications can publish the desired state to the shadow of a device. The device can synchronize its state the next time it connects.

Message Delivery

AWS IoT supports quality of service levels 0 (at most once) and 1 (at least once) as described in the MQTT standard [56] when sending or subscribing to topics for MQTT and REST requests. It does not support level 2 (exactly once) which means that duplicate messages can occur [47].

In case an action is triggered by a rule but the destination is unavailable, AWS IoT can wait for up to 24 hours for it to become available again. This can happen if the destination S3 bucket was deleted, for example.

The official documentation [44] states that failed actions are not retried. That is however not the observed behavior, and statements by AWS officials suggest that individual limits for each service exist [55]. For example AWS IoT can try to deliver a message to Lambda up to three times and up to five times to DynamoDB.

Scalability

AWS IoT is a scalable, robust and convenient-to-use service to connect a very large number of devices to the cloud. It is capable of sustaining bursts of several thousand simulated devices, publishing data on the same topic without any failures.

Service Limits

Table 5.1 aka FIG. 4a covers limits that apply to AWS IoT. All limits are typically hard limits hence cannot be increased. AWS IoT's limits are described in [60].

5.1.2 AWS CloudFormation

CloudFormation is a service that allows to describe and deploy infrastructure to the AWS cloud. It uses a declarative template language to define collections of resources. These collections are called stacks [35]. Stacks can be created, updated and deleted via the AWS web interface, the AWS cli or a number of third party applications like troposphere and cfn-sphere (https://github.com/cloudtools/troposphere and https://github.com/cth-sphere/cfn-sphere).

AWS Resources and Custom Resources

CloudFormation only supports a subset of the services offered by AWS. The full list of currently supported resource types and features can be found in [36]. A CloudFormation stack is a resource too and can as such be created by another stack. This is referred to as nesting stacks [37].

It is also possible to extend CloudFormation with custom resources. This can be done by implementing an AWS Lambda function that provides the create, delete and update functionality for the resource. More information on custom resources and how to implement them can be found in [38].

Deleting a Stack

When a stack is deleted, the default behavior is to remove all resources associated with it. For resources containing data like RDS instances and DynamoDB tables, this means the data held might be lost. One solution to this problem is to back up the data to a different location before the stack is deleted. But this moves the responsibility outside of CloudFormation and oversights can occur. Another solution is to override this default behavior by explicitly specifying a DeletionPolicy with a value of Retain. Alternatively, the policy Snapshot can be used for resources that support the creation of snapshots. CloudFormation may then either keep the resource, or create a snapshot before deletion.

S3 buckets are an exception to this rule because it is not possible to delete a bucket that still contains objects. While this means that data inside a bucket is implicitly retained when a stack is deleted, it also means that CloudFormation can run into an error when it tries to remove the bucket. The service can still try to delete any other resources, but the stack can be left in an inconsistent state. It is therefore good practice to explicitly set the DeletionPolicy to Retain as shown in the sample template provided in FIG. 5a aka listing 5.1. [39]

Service Limits

Table 5.2 aka FIG. 4b (AWS CloudFormation service limits) covers limits that apply to the CloudFormation service itself and stacks. Limits that apply directly to templates and stacks cannot be increased. However, they can be somewhat circumvented by using nested stacks. The nested stack is counted as a single resource and can itself include other stacks again.

5.1.3 Amazon Simple Workflow (SWF)

Amazon Simple Workflow (SWF) is a workflow management service available in the AWS cloud. The service maintains the execution state of workflows, tracks workflow versions and keeps a history of past workflow executions.

The service distinguishes two different types of tasks that make up a workflow:

Decision tasks implement the workflow logic. There is a single decision task per workflow. It makes decisions about which activity task can be scheduled next for execution based on the execution history of a workflow instance.

Activity tasks implement the steps that make up a workflow.

Before a workflow can be executed it can be assigned to a domain which is a namespace for workflows. Multiple workflows can share the same domain. In addition, all activities making up a workflow can be assigned a version number and registered with the service.

FIG. 6b aka FIG. 5.2 is a simplified flow diagram showing an exemplary flow of control during execution of a workflow instance. Once a workflow has been started, the service schedules the first decision task on a queue. Decider workers poll this queue and return a decision. A decision can be to abort the workflow execution, to reschedule the decision after a timer runs out, or to schedule an activity task. If an activity task can be scheduled, it is put in one of the activity task queues. From there it is picked up by a worker, which executes the task and informs the service of the result, which, in turn, schedules a new decision task and the circle continues until a decider returns the decision that the workflow either should be aborted or has been completed [24].

Amazon SWF assumes nothing about the workers executing tasks. They can be located on servers in the cloud or on premises. There can be very few workers running on large machines, or hundreds of small ones. SWF typically needs to be able to poll the service for tasks.

This makes it convenient to scale the amount of workers on demand. SWF also allows to implement activity tasks (but not decision tasks) using AWS Lambda which makes scaling even easier [25].

AWS supplies SDKs for Java, Python, .NET, Node.js, PHP and Ruby to develop workflows as well as the Flow Frameworks for Java and Ruby which use a higher abstraction level when developing workflows and even handle registration of workflows and domains through the service. As a low level alternative, the HTTP API of the service can also be used directly [26].

Service Limits

The table of FIG. 4c (Amazon Simple Workflow service limits) describes default limits of the Simple Workflow service and whether they can be increased. A complete list of limits and how to request an increase can be found in [27].

5.1.4 AWS Data Pipeline

AWS Data Pipeline is a service to automate moving and transformation of data. It allows the definition of data-driven workflows called pipelines. Pipelines typically comprise a sequence of activities which are associated with processing resources. The service offers a number of common activities, for example to copy data from S3 and run Hadoop, Hive or Pig jobs. Pipelines and activities can be parameterized but no new activity types can be added. Available activity types and pipeline solutions are described in [40].

Pipelines can be executed on a fixed schedule or on demand. AWS Lambda functions can act as an intermediary to trigger pipelines in response to events.

The service can take care of the creation and destruction of all compute resources like EC2 instances and EMR clusters necessary to execute a pipeline. It is also possible to use existing resources in the cloud or on a premises. For this the TaskRunner program can be installed on the resources and the activity can be assigned a worker group configured on one of those resources. [41]

The Pipeline Architect illustrated in FIG. 5.3. aka FIG. FIG. 6c is a visual designer and part of the service offering. It can be used to define workflows without the need to write any code or configuration files.

The designer allows the export of pipeline definitions in a JSON format. Experience shows that it is easiest to build the pipeline using the architect, then export it using the AWS Python SDK. The resulting JSON may then be adjusted to be usable in CloudFormation templates.

Service Limits

The table of FIG. 4d (AWS Data Pipeline service limits) gives an overview of default limits of the Data Pipeline service and whether they can be increased. The complete overview of limits and how to request an increase is available at [42]. These are only the limits directly imposed by the Data Pipeline service. Account limits like the number of EC2 instances that can be created, can impact the service too, especially when, for example, large EMR clusters are created on demand. Re footnote 1, this is a lower limit which typically can't be decreased any further.

5.1.5 Amazon Kinesis Firehose

Kinesis Firehose is a fully managed service with the singular purpose of delivering streaming data. It can either store it in S3, or load it into a Redshift data warehouse cluster, or an Elasticsearch Service cluster.

Delivery Mechanisms

Kinesis Firehose delivers data to destinations in batches. The details depend on the delivery destination. The following list summarizes some of the most relevant aspects for each destination. [14]

Amazon S3 The size of a batch can be given as a time interval from 1 to 15 minutes and an amount of 1 to 128 megabytes. Once either the time has passed, or the amount has been reached, Kinesis Firehose can trigger the transfer to the specified bucket. The data can be put in a folder structure which may include the date and hour the data was delivered to the destination and an optional prefix. Additionally, Kinesis Firehose can compress the data with ZIP, GZIP or Snappy algorithms and encrypt the data with a key stored in Amazon's key management service KMS e.g. as shown in FIG. 5.4 aka FIG. 6d.

Kinesis Firehose can buffer data for up to 24 hours if the S3 bucket becomes unavailable or if it falls behind on data delivery.

Amazon Redshift Kinesis Firehose delivers data to a Redshift cluster by sending it to S3 first. Once a batch of data has been delivered, a COPY command is issued to the Redshift cluster and it can begin loading the data. A table with columns fitting the mapping supplied to the command can already exist. After the command completes, the data is left in the bucket.

Kinesis Firehose can retry delivery for up to approximately 7200 seconds then move the data to a special error folder in the intermediary S3 bucket.

Amazon Elasticsearch Service Data to an Elasticsearch Service domain is delivered without a detour over S3. Kinesis Firehose can buffer up to approximately 15 minutes or approximately 100 MB of data then send it to the Elasticsearch Service domain using a bulk load request.

As with Redshift, Kinesis Firehose can retry delivery for up to approximately 7200 seconds then deliver the data to a special error folder in a designated S3 bucket.

Scalability

The Kinesis Firehose service is fully managed. It scales automatically up to the account limits defined for the service.

Service Limits

Table 4e (Amazon Kinesis Firehose service limits) describes default limits of the Kinesis Firehose service and whether they can be increased. The limits on transactions, records and MB can only be increased together. Increasing one also increases the other two proportionally. All limits apply per stream. A complete list of limits and how to request an increase can be found in [15].

5.1.6 AWS Lambda

The AWS Lambda service provides a computing environment, called a container, to execute code without the need to provision or manage servers. A collection of code that can be executed by Lambda is called a function. When a Lambda function is invoked, the service provides its code in a container, and calls a configured handler function with the received event parameter. Once the execution is finished, the container is frozen and cached for some time so it can be reused during subsequent invocations.

Generally speaking, this means Lambda functions do not retain state across invocations. If the result of a previous invocation is to be accessed, an external database can be used. However, in case that the container is unfrozen and reused, previously downloaded files can still be there. The same is true for statically initialized objects in Java or variables defined outside the handler function scope in Python. It is advisable to take advantage of this behavior because the execution time of Lambda functions is billed in 100 millisecond increments [48].

All function code is written in one of the supported languages. Currently Lambda supports functions written in Node.js, Java, Python and C#.

Possibly the biggest limitation of Lambda is the maximum execution time of 300 seconds. If a function does not complete inside this limit, the container is automatically killed by the service. Functions can retrieve information about the remaining execution time by accessing a context object provided by the container.

To cut down execution time, the Lambda function size can be increased by allocating more memory. Memory can be assigned to functions in increments of 64 MB starting at 128 MB and ending at 1536 MB. Allocating more memory automatically increases the processing power used to execute the function and the service fee by roughly the same ratio.

Invocation Models

When a Lambda function is connected to another service it can be invoked in asynchronous or synchronous fashion. In the asynchronous case, the function is invoked by the service that generated the event. This is for example what happens when a file is uploaded to S3. A CloudWatch alarm is triggered or a message is received by AWS IoT. In the synchronous case, also called stream-based, there is no event. Instead, the Lambda service can poll the other service at regular intervals and invoke the function when new data is available. This model is used with Kinesis when new records are added to the stream or DynamoDB when an item is inserted. The Lambda service can also invoke a function on a fixed schedule given as a time interval or a Cron expression [49].

Scalability

The Lambda service is fully managed and can scale automatically without any configuration from very few requests per day, to thousands of requests per second.

Service Limits

Table 4f (AWS Lambda service limits) describes default limits of the AWS Lambda service and whether they can be increased. A complete list of limits is described in [50].

Regarding the number of concurrent executions given for Lambda functions, while Lambda can potentially execute this many functions per second, other limiting factors can be considered.

For streaming sources like Kinesis, the Lambda service typically does not run more concurrent functions than the number of shards in the stream. In this case, the stream limits Lambda because the content of a shard is typically read sequentially, therefore no more than one function can process the contents of a shard at a time.

Furthermore, regarding the definition for the number of concurrent function invocations, a single function invocation can count as more than a single concurrent invocation. For event sources that invoke functions asynchronously, the value of concurrent Lambda executions may be computed from the following formula:

concurrent invocations=events per second*average function duration

A function that is invoked 10 times per second and takes three seconds to complete therefore counts not as 10 but 30 concurrent Lambda invocations against the account limit [51].

5.1.7 Amazon Kinesis Streams

Kinesis Streams is a service capable of collecting large amounts of streaming data in real time. A stream stores an ordered sequences of records. Each record is composed of a sequence number, a partition key and a data blob.

FIG. 6e shows a high-level view of a Kinesis stream. A stream typically includes shards with a fixed capacity for read and write operations per second. Records written to the stream are distributed across its shards based on their partition key. To make use of a stream's capacity, the partition key can be chosen in a way to provide equal distribution of records across all shards of a stream.

The Amazon Kinesis Client Library (KCL) provides a convenient way to consume data from a Kinesis stream in a distributed application. It coordinates the assignment of shards to consumers and ensures redistribution of shards when new consumers join or leave and shards are removed or added. Kinesis streams and KCL are known in the art and described e.g. in [18].

Scalability

Kinesis streams do not scale automatically. Instead, a fixed amount of capacity is typically allocated to the stream. If a stream is overwhelmed, it can reject requests to add more records and the resulting errors can be handled by the data producers accordingly.

In order to increase the capacity of a stream, one or more shards in the stream have to be split. This redistributes the partition key space assigned to the shard to the two resulting child shards. Selecting which shard to split proceeds as per knowledge of the distribution of partition keys across shards. A method for how to re-shard a stream and how to choose which shards to split or merge is known in the art and described e.g. in [19].

AWS added a new operation named UpdateShardCount to the Kinesis Streams API. It allows to adjust a stream's capacity simply by specifying the new number of shards of a stream. However, the operation can only be used twice inside of a 24 hour interval and it is ideally used either for doubling or halving the capacity of a stream. In other scenarios it can create many temporary shards during the adjustment process to achieve equal distribution of the partition key space (and the stream's capacity) again [16].

Service Limits

Table 4g (Amazon Kinesis Streams service limits) describes default limits of the Kinesis Streams service and whether they can be increased. The complete list of limits and how to request an increase can be found in [20]. Re footnote 1, typically Retention can be increased up to a maximum of 168 hours. Footnote 2: Whichever comes first.

5.1.8 Amazon Elastic Map-Reduce (EMR)

The Amazon EMR service provides the ability to analyze vast amounts of data with the help of managed Hadoop and Spark clusters.

AWS provides a complete package of applications for use with EMR which can be installed and configured when the cluster is provisioned. EMR clusters can access data stored in S3 transparently using the EMR File System EMRFS which is Amazon's implementation of the Hadoop Distributed File System (HDFS) and can be used alongside native HDFS. [11]

EMR uses YARN (Yet Another Resource Negotiator) to manage the allocation of cluster resources to installed data processing frameworks like Spark and Hadoop MapReduce. Applications that can be installed automatically include Flink, HBase, Hive, Hue, Mahout, Oozie, Pig, Presto and others [10].

Scalability

There are various known solutions to scale an EMR cluster with each solution having its advantages.

EMR Auto Scaling Policies were added by AWS in November 2016. These have the ability to scale not only the instances of task instance groups, but can also safely adjust the number of instances in the core Hadoop instance group which holds the HDFS of the cluster.

Defining scaling policies is currently not supported by CloudFormation. One way to currently add a scaling policy is manually via the web interface [12].

emr-autoscaling is an open source solution developed by ImmobilienScout24 that extends Amzon EMR clusters with auto scaling behavior (https://www.immobilienscout24.de/). Its source code was published on their public GitHub repository in May 2016 (https://github.com/ImmobilienScout24/emr-autoscaling).

The solution is comprised of a CloudFormation template and a Lambda function written in Python. The function is triggered in regular intervals by a CloudWatch timer. It adjusts the number of instances in the task instance groups of a cluster. Task instance groups using spot instances are eligible for scaling [66].

Data Pipeline provides a similar method of scaling. It is typically only available if the Data Pipeline service is used to manage the EMR cluster. It is then possible to specify the number of task instances that can be added before an activity is executed when the pipeline is defined. The service can then add task instances using the spot market and remove them again once the task has completed.

One solution is to specify the number of task instances that can be available in the pipeline definition of an activity. Another solution can be if EMR scaling policies are added to CloudFormation. A solution by ImmobilienScout24 is one that can be deployed with CloudFormation.

Service Limits

No limits are imposed on the EMR service directly. However, it can be impacted by the limits of other services. The most relevant one is the limit for active EC2 instances in an account. Because the default limit is set somewhat low at 20 instances, it can be exhausted fast when creating clusters.

5.1.9 Amazon Athena

AWS introduced a new service named Amazon Athena. It provides the ability to execute interactive SQL queries on data stored in S3 in a serverless fashion [5].

Athena uses Apache Hive data definition statements to define tables on objects stored in S3. When the table is queried, the schema is projected on the data. The defined tables can also be accessed using JDBC. This enables the usage of business intelligence tools and analytics suites like Tableau (https://www.tableau.com).

Analytics use cases that require an EMR cluster can be evaluated and implemented with it.

5.1.10 AWS Batch

AWS Batch is a new service announced in December 2016 at AWS re:Invent and is currently only available in closed preview (https://reinvent.awsevents.com/). It provides the ability to define workflows in open source formats and executes them using Amazon Elastic Container Service (ECS) and Docker containers. The service automatically scales the amount of provisioned resources depending on job size and can use the spot market to purchase compute capacity at cheaper rates.

5.1.11 Amazon Simple Storage Service (S3)

Amazon S3 provides scalable, cheap storage for vast amounts of data. Data objects are organized in buckets, which may be regarded as a globally unique name space for keys. The data inside a bucket can be organized in a file system such as abstraction with the help of prefixes.

S3 is well integrated with many other AWS services and may be used as a delivery destination for streaming data in Kinesis Firehose and the content of an S3 bucket can be accessed from inside an EMR cluster.

Service Limits

The number of buckets is the only one limit given in [22] for the service. It can be increased from the initial default of 100 on request. In addition, [23] also mentions temporary limits on the request rate for the service API. In order to avoid any throttling, AWS advises to notify them beforehand if request rates are expected to rapidly increase beyond 800 GET or 300 PUT/LIST/DELETE requests per second.

5.1.12 Amazon DynamoDB

DynamoDB is a fully managed schemaless NoSQL database service that stores items with attributes. Before a table is created, an attribute is typically declared as the partition key. Optionally, another one can be declared as a sort key. Together these attributes form a unique primary key and every item to be stored in the table may be required to have the attributes making up the key. Aside from the primary key attributes, the items in the can be arbitrarily many other attributes. [6]

Scalability

Internally, partition keys are hashed to assign items to data partitions. To ensure optimal performance, the partition key may be chosen to distribute the stored items equally across data partitions.

DynamoDB does not scale automatically. Instead, write capacity units (WCU) and read capacity units (RCU) to process write and read requests can be provisioned for a table when it is created [7].

RCU One read capacity unit represents one strongly consistent read, or two eventually consistent reads, per second for items smaller than 4 KB in size.

WCU One write capacity unit represents one write per second for items up to 1 KB in size.

Reading larger items uses up multiple complete RCU, and the same applies to writing items and WCU. It is possible to make more efficient use of capacity units by using batch write and read operations which consume capacity units equal to the size of the complete batch, instead for each individual item.

Should the capacity of a table be exceeded, then the service can stop accepting write or read requests. The capacity of a table can be increased an arbitrary amount of times, but it can only be decreased four times per day.

DynamoDB publishes metrics for each table to Cloudwatch. These metrics include the used write and read capacity units. A Lambda function that is triggered on a timer can evaluate these Cloudwatch metrics and adjust the provisioned capacity accordingly.

To ensure there is always enough capacity provided, the scale-up behavior can be relatively aggressive and add capacity in big steps. Scale-down behavior, on the contrary, can be very conservative. Especially if the number of capacity decreases per day are limited to four, it can be avoided to scale-down too early.

Service Limits

Table 4h (Amazon DynamoDB service limits) stipulates limits that apply to the service and tables. A description of all limits and how to request an increase is available in [8].

5.1.13 Amazon RDS

Amazon RDS is a managed service providing relational database instances. Supported databases are Amazon Aurora, MySQL, MariaDB, Oracle, Microsoft SQL Server and PostgreSQL. The service handles provisioning, updating of database systems, as well

as backup and recovery of databases. Depending on the database engine, it provides scale-out read replicas, automatic replication and fail-over [21].

As common in relational databases, scaling write operations is only possible by scaling vertically. Because of the variable nature of IoT data and the expected volume of writes, the RDS service is likely only an option as a result serving database.

5.1.14 Other Workflow Management Systems

A number of workflow management systems may be used to manage execution schedules of analytics workflows and dependencies between analytics tasks.

Luigi

Luigi is a workflow management system originally developed for internal use at Spotify before it was released as an open source project in 2012 (https://github.com/spotify/luigi and https://www.spotify.com/).

Workflows in Luigi are expressed in Python code that describes tasks. A task can use the require statement to express its dependency on the output of other tasks. The resulting tree models the dependencies between the tasks and represents the workflow. The focus of Luigi is on the connections (or plumbing) between long running processes like Hadoop jobs, dumping/loading data from a database or machine learning algorithms. It comes with tasks for executing jobs in Hadoop, Spark, Hive and Pig. Modules to run shell scripts and access common database systems are included as well. Luigi also comes with support for creating new task types and many task types have been contributed by the community [57].

Luigi uses a single central server to plan the executions of tasks and ensure that a task is executed exactly once. It uses external trigger mechanisms such as crontab for triggering tasks.

Once a worker node has received a task from the planner node, that worker is responsible for the execution of the task and all prerequisite tasks to complete it. This means the worker can execute the complete workflow and not take advantage of parallelism inside a workflow execution. This can generate a problem when running thousands of small tasks. [58, 59]

Airflow

Airflow describes itself as “[ . . . ] a platform to programmatically author, schedule and monitor workflows.” ([30]) (https://airflow.apache.org) It was originally developed at Airbnb and was made open source in 2015 before joining the incubation program of the Apache Software Foundation in spring 2016 (https://www.airbnb.com).

Airflow workflows are modeled as directed acyclical graphs (DAG) and expressed in Python code. Workflow tasks are executed by Operator classes. The included operators can execute shell and Python scripts, send emails, execute SQL commands and Hive queries, transfer files to/from S3 and much more. Airflow executes workflows in a distributed fashion scheduling the tasks of a workflow across a fleet of worker nodes. For this reason workflow tasks may include independent units of work [1].

Airflow also features a scheduler to trigger workflows on a timer. In addition, a special Sensor operator exists which can wait for a condition to be satisfied (like the existence of a file or a database entry.) It is also possible to trigger workflows form external sources. [2]

Oozie

Oozie is a workflow engine to manage Apache Hadoop jobs which has three main parts (https://oozie.apache.org/). The Workflow Engine manages the execution of workflows and their steps, the Coordinator Engine schedules the execution of workflows based on time and data availability and the Bundle Engine manages collections of coordinator workflows and their triggers. [75]

Workflows are modeled as directed acyclical graphs including control flow and action nodes. Action nodes represent the workflow steps which can be a Map-Reduce, Pig or SSH action for example. Workflows are written in XML and can be parameterized with a powerful expression language. [76, 77]

Oozie is available for Amazon EMR since version 4.2.0. It can be installed by enabling the Hue (Hadoop User Experience) package. [13]

Azkaban

Azkaban is a scheduler for batch workflows executing in Hadoop (https://azkaban.github.io/). It was created at LinkedIn with a focus on usability and provides a convenient-to-use web user interface to manage and track execution of workflows (https://www.linkedin.com/).

Workflows include Hadoop jobs which may be represented as property files that describe the dependencies between jobs.

The three major components [53] making up Azkaban are:

Azkaban web server The web server handles project management and authentication. It also schedules workflows on executors and monitors executions.

Azkaban executor server The executor server schedules and supervises the execution of workflow steps. There can be multiple executor servers and jobs of a flow can execute on multiple executors in parallel.

MySQL database server The database server is used by executors and the web server to exchange workflow state information. It also keeps track of all projects, permissions on projects, uploaded workflow files and SLA rules.

Azkaban uses a plugin architecture for everything not part of the core system. This makes it easily extendable with modules that add new features and job types. Plugins that are available by default include a HDFS browser module and job types for executing shell commands, Hadoop shell commands, Hadoop Java jobs, Pig jobs, Hive queries. Azkaban even comes with a job type for loading data into Voldemort databases (https://www.project-voldemort.com/voldemort/). [54]

Amazon Simple Workflow

If there is a need to schedule analytics and manage data flows, Amazon SWF may be a suitable service choice, being fully managed auto scaling service and capable of using Lambda, which is also an auto scaling service, to do the actual analytics work.

In SWF, workflows are implemented using special decider tasks. These tasks cannot take advantage of Lambda functions and are typically executed on servers.

SWF assumes workflow tasks to be independent of execution location. This means a database or other persistent storage outside of the analytics worker is required to aggregate the data for an analytics step. The alternative, transmitting the data required for the analytics from step to step through SWF, is not really an option, because of the maximum input and result size for a workflow step. The limit of 32,000 characters is easily exceeded e.g. by the data sent by mobile phones. This is especially true when the data from multiple data packets is aggregated.

Re-transmitting data can be avoided if it can be guaranteed that workflow steps depending on this data are executed in the same location. Task routing is a feature that enables a kind of location awareness in SWF by assigning tasks to queues that are only polled by designated workers. If every worker has its private queue, it can be ensured that tasks are always assigned to the same worker. Task routing can be cumbersome to use. A decider task for a two-step workflow with task routing implemented using the AWS Python SDK, can require close to 150 lines of code. Java Flow SDK for SWF leverages annotation processing to eliminate much boiler plate code needed for decider tasks, but does not support task routing.

A drawback is that there is no direct integration from AWS IoT to SWF which may mean the only way to start a workflow is by executing actual code somewhere and the only possibility to do this without additional servers may be to use AWS Lambda. This may mean that AWS IoT would have to invoke a function for every message that is sent to this processing lane only to signal the SWF service. According to certain embodiments, Amazon SWF is not used in the stateful stream processing lane and the lane is not implemented using services exclusively. Instead, virtual servers may be used e.g. if using Lambda functions exclusively is not desirable or possible.

Luigi and Airflow

Amazon SWF is a possible workflow management system; other possible candidates include Luigi and Airflow which both have weaknesses in the usage scenario posed by the stateful stream processing lane.

Analytics workflows in this lane are typically short-lived and may mostly be completed in a matter of seconds, or sometimes minutes. Additionally, a very large number of workflow instances, possibly thousands, may be executed in parallel. This is similar to the scenario described by the Luigi developers in [59] in which they do not recommend using Luigi.

Airflow does not have the same scaling issues as Luigi. But Airflow has even less of a concept of task locality than Amazon SWF. Here tasks are required to be independent units of work, which includes being independent of execution location.

In addition, typically, both systems must either be integrated with AWS IoT via AWS Lambda or using an additional component that uses either the MQTT protocol or AWS SDK functions to subscribe to topics in AWS IoT. In both cases the component may be a custom piece of software and may have to be developed.

For these reasons, a workflow management system may not be used in this lane.

Memcached and Redis

Since keeping data local to the analytics workers and aggregating the data in the windows required by the analytics may be non-trivial, caching systems may be employed to collect and aggregate incoming data.

Memcached caches may be deployed on each of the analytics worker instances. All of the management logic for inserting data into the cache may be implemented so it can be found again, assembling sliding windows, scheduling analytics executions. A single Redis cluster may be used to cache all incoming data. Redis is available in Amazon's Elasticache service and offers a lot more functionality than Memcached. It could be used as a store for the raw data and as system to queue analytics for execution on worker instances. While Redis supports scale-out for reads, it only supports scales-up for writes. Typically, scale-up requires taking the cluster offline. This not only means it is unavailable during reconfiguration, but also that any data stored in the cache is lost unless a snapshot was created beforehand.

The function can be easily deployed for multiple tables and a different set of limits for the maximum and minimum allowed read and write capacities as well as the size of the increase and decrease steps can be defined for each table without needing to change its source code.

As an alternative autoscaling functionality is now also provided by Amazon as part of the DynamoDB service.

The classes of FIG. 3b may be regarded as example classes.

Analysis of common analytics use cases e.g. as described herein with reference to analytics classes, yielded a classification system that categorizes analytics use cases or families thereof into one of various analytics classes e.g. the following 4 classes, using the dimensions shown and described herein:

CLASS A—Stateless, streaming, data point granularity

CLASS B—Stateless, streaming, data packet granularity

CLASS C—Stateful, streaming, data shard granularity

CLASS D—Stateful, batch, data chunk granularity

Mapping a distribution of common analytics use cases across the classes yielded the insight that a platform capable of supporting the requirements of at least the above four classes would be able to support generally all common analytics use cases. for example, a platform may be designed as a three layered architecture where the central processing layer includes three lanes that each support different types of analytics classes. for example, a stateless stream processing lane may cover or serve one or both of classes A and B, and/or a Stateful stream processing lane may serve class C and/or a Stateful batch processing lane may serve class D. A Raw data pass-through lane may be provided that does no analytics hence supports or covers none of the above classes.

In FIG. 3c inter alia, it is appreciated that uni-directional data flow as indicated by uni-directional arrows may according to certain embodiments be bi-directional, and vice versa. For example, the arrow between the data ingestion layer component and stateful stream processing lane may be bi-directional, although this need not be the case, the pre-processed data arrow between data ingestion and stateless processing may be bi-directional, although this need not be the case, and so forth.

Referring again to FIG. 9a, it is appreciated that conventionally, developers aka programmers write computer executed code, in-factory, for an IoT analytics platform typically including the actual analytics code and the platform where the actual analytics code runs.

According to certain embodiments, the assistant of FIG. 9a, some or all of whose modules may be provided, is one of multiple auxiliary components of, or integrated into, the platform such as (the assistant as well as) various execution environments, various analytics, logging modules, monitoring modules, etc. alternatively, the assistant may integrate with other systems able to provide suitable inputs to the assistant and/or to accept suitable outputs therefrom e.g. as described herein with reference to FIG. 9a. regarding the inputs to the assistant, data scientists may manually produce analytics use case descriptions e.g. as described herein, and developers may manually produce execution environment descriptions e.g. as described herein. Regarding outputs from the assistant of FIG. 9a, these are typically fed to an IoT analytics platform; If that platform is a legacy platform it may be modified so it will communicate properly with the assistant and responsively, configure itself appropriately.

Deployment, occurring later i.e. downstream of development, refers to installation of the program produced by the developers, at a customer side, typically with whichever features and configuration the customer aka end-user requires for her or his specific individual installation since there are ordinarily differences between installations for different end-users. An installation may thus typically be thought of as an instance of the program that typically runs on corresponding (virtual) machines and has a corresponding configuration. During deployment, the deployment team installs what the individual end-user currently needs by suitably tailoring or customizing the developers' work-product accordingly. Conventionally, deployment includes deployment of analytics use cases that are to be realized and respective processing environment/s where those analytics use-cases can run. The matching of analytics to lanes is done manually and at deployment time. However, according to certain embodiments, the development and subsequently deployment advantageously include the assistant of FIG. 9a which may then, after deployment rather than during deployment, automatically rather than manually, map analytics use cases to various (potentially) available execution environments installed during deployment.

Therefore, a particular advantage of certain embodiments is that assignment need not be done mentally, in deployers' heads and need not remain, barring human deployers' intervention, fixed as it was deployed—as occurs in practice, at the present time. When this occurs, then if something new, such as a new use-case occurs, deployers need to actively change their work in anticipation of this, or retroactively and/or preventively deploy it (e.g. retroactively match a newly needed analytics use-case to a suitable lane) which, particularly since humans are involved is inefficient, time consuming, error-prone and wasteful of resources, and also does not scale with the number of installations unless the deployment team is scaled as a function of the number of installations. In contrast, according to certain embodiments, the deployment team configures the system at deployment time after which, thanks to the assistant of FIG. 9a, all assignments may then be done automatically. It is appreciated that deploying only what is currently needed is far more efficient and parsimonious of resource than are the current techniques being used in the field, and also enjoys a far better scaling behavior, since less deployers can be responsible for more installations.

Typically, end-users are computerized organizations who seek to apply IoT analytics to their field of work or domain e.g. sports, entertainment or industry. IoT analytics may be applied in conjunction with content (video clips, video overlays, statistics, social feeds, . . . ) which may be generated by end-users on e.g. basketball games or fashion shows. Another example is Industry 4.0, where end-users may seek to achieve predictive maintenance. Typically, the following process (process A) may be performed:

1. Provide an IoT analytics platform capable of ingesting data from a wide variety of sensors and applying a wide variety of analytics to that data.

2. A given end-user wants to produce certain content for a given event. E.g. end-user X wants to produce live video overlays on basketball players during a game, indicating the height of the players' jumps. In addition the end-user may, say, want access to acceleration data of all players on the field so as to query same, typically using relatively complex queries run on special additional analytics, in an ad-hoc mode (e.g. during breaks or after the end of the game). The set of possible queries may be fixed and known in advance e.g. at deployment time, but which queries will actually be used and when is unknown at deployment time.

3. IoT platform is installed with whichever modules and configurations are needed to ingest the given sensor data and produce the respective analytics results. This is achieved by human deployment team which manually configures the system to run the needed analytics in what they deem to be suitable execution environments.

4. All queries that need additional analytics, may be deployed beforehand, although some may not be needed in the end.

5. If requirements change during runtime, e.g. new analytics are deemed needed that were not communicated by the end-user to the deployment team at deployment time, the deployment team has to manually adapt the system.

However, provision of the automated assistant of FIG. 9a typically improves or obviates operations 4 and/or 5.

A preferred method for connection (aka process B) may include some or all of the following operations a-f, suitably ordered e.g. as shown:

a. Data scientists produce ready to use analytics code typically satisfying requirements provided by human product managers. This code meets certain analytics use cases (of possibly vastly different complexities), such as, just by way of example, data cleansing, jump detection, or weather forecast.

b. The data scientists also produce descriptions e.g. in JSON format for each of the analytics use cases. The actual values of the various dimensions may be provided in or by the requirements provided by human product managers or may represent what the data scientists actually managed to achieve (e.g. if requirements were not successfully met or, for certain dimension/s, were not specified in the requirements provided by human product managers)

c. Developers produce execution environments, including ready to use code and typically satisfying requirements provided by product management. This code meets certain execution needs (of possibly vastly different complexities), such as, just by way of example, small volume numeric data processing or big volume video data processing.

d. The developers also produce descriptions e.g. in JSON format for each of the execution environments. The actual values of the various dimensions may be provided in or by the requirements provided by human product managers or may represent what the developers actually managed to achieve (e.g. if requirements were not successfully met or, for certain dimension/s, were not specified in the requirements provided by human product managers)

e. All code and descriptions (analytics and execution) are stored in a state-of-the art repository as part of the delivery process, e.g. manually.

f. Analytics use case and/or configuration descriptions are delivered or otherwise made available to the assistant, e.g. by using a repository to make the assistant operative responsively.

A method, aka process C, for performing operation f above according to certain embodiments, is now described in detail. The method for delivering descriptions available in the repository, to the assistant may include some or all of the following operations, suitably ordered e.g. as shown:

1. During deployment, deployment team copies all “allowed” (for a given end-user) analytics and configurations (environments) to a fresh dedicated repository for the installation at hand. What is allowed or not may be decided by a human responsible or by automated rules derived, say, from license agreements.

2. Deployment team marks analytics to be deployed static, i.e. operational from beginning of installation or deployment. The decision on which to mark may be made by the deployment team or automated rules may be applied. Marking may comprise adding a new field “mode” to the formal e.g. JSON description (e.g. “static” indicates analytics which are deployed from the beginning, as opposed to “dynamic” analytics which may be made later on demand, using the assistant of FIG. 9a.

3. Deployment team runs a first program which delivers all static analytics and environments to the assistant as defined. Program terminates once all marked analytics have been delivered.

4. A second program, constantly running, may be connected to the query and response interfaces of the IoT platform, which holds information on all possible queries and, for each, which kind of analytics use cases and which execution runtimes are associated therewith. This information may be generated by the deployment team for the specific installation at hand and/or additional inputs such as but not limited to information, e.g. from a domain expert or other human expert, may additionally be used.

5. The second program reacts to queries issued to the IoT platform and if a query is issued that is associated with a not (yet) deployed analytics or environment, the second program sends the formal descriptions of the not (yet) deployed analytics or environment to the assistant.

6. Optionally, or by configuration, the assistant is called after the query result has been delivered to remove the respective analytics and/or environments.

According to one embodiment, both programs are tailored to the exact installation at hand and only usable for that. Alternatively, the first and second programs may be configurable and/or reactive to the actual installation so as to be general for (reusable for) all installations.

It is possible to interact with the Assistant other than as above, e.g. triggering manually, by a human supervisor overseeing the current installation during runtime. A GUI may be provided to the human supervisor, e.g. with X virtual buttons for triggering Y pre-defined actions respectively. Even if triggering is manual, the resulting semi-automated process (in which the method for performing operation f is omitted) is still more efficient than deploying and undeploying analytics and environments manually. Similarly, even the resulting semi-automated process (in which the method for performing operation f is omitted) is still less error prone than deploying and undeploying analytics and environments manually as is conventional, both because options are restricted, and because less skills are required thus reducing human error.

Any suitable technology may be employed to deliver a formal description (e.g. JSON description provided by a data scientist) to the platform, typically together with the actual program code of the analytics, typically using a suitable data repository or data store. One example delivery method, aka process D, may include some or all of the following operations, suitably ordered e.g. as shown:

1. Provide a data store which may for example comprise a JSON data base, able to store and query JSON structures out of the box. Caching as known in the state of the art may be applied to minimize the read operations on the data store. In the following description caching is ignored for simplicity.

2. Configuration descriptions may be delivered to the assistant e.g. as described herein with reference to “process C”.

3. The Configuration Module of FIG. 9a accepts the configuration descriptions, performs a conventional syntax and plausibility check, rejects in cases of violation, and stores at least all non-rejected configurations in the data store. Optionally, each new configuration overwrites an already existing configuration if any. Alternatively, versioning, merging or other alternatives to overwriting may be used as known in the art. It is also typically possible to request existing configurations from the data store or delete existing configurations; both e.g. using dedicated inputs.

4. Configuration for all modules (including the Configuration Module) is read from the data store. E.g. the categorization value is read by the Categorization module, indicating if and to what degree “bigger” environments may be used for “smaller” analytics.

5. Due to configuration, user interaction may be conducted at any time to confirm modifications or request actions.

6. Analytics use case descriptions are delivered to the assistant e.g. as described herein with reference to “process C”.

7. Classification Module of FIG. 9a accepts the analytics use case descriptions, performs a conventional syntax and plausibility check, and rejects in case of violation. Then the classification module of FIG. 9a augments analytics use case descriptions by a “class” field if not already there; all analytics use cases (typically including analytics use case descriptions that may already be available in the data store) that have exactly the same values for all their dimensions are assigned the same value in the class field. If a new value for the class dimension is needed, a unique identifier is generated as known in the art.

8. Classification Module of FIG. 9a stores the (augmented) analytics use case descriptions in the data store. Optionally, a new analytics use case descriptions overwrites a possibly already existing one with the same ID. Alternatively, versioning, merging or other alternatives to overwriting may be used as known in the art. It is also typically possible to request existing analytics use case descriptions from the data store or delete existing configurations, both e.g. using dedicated inputs.

9. The Classification module of FIG. 9a typically triggers the Clustering Module, e.g. by directly providing the current analytics use case description to the clustering module.

10. The Clustering Module reads all available analytics use case descriptions from the data store, perhaps excepting the most current one which may have been provided directly.

11. Analytics use case descriptions are augmented by a field “cluster” If not already there, by the clustering module. All analytics use cases that have exactly the same class are assigned the same value in the cluster field. In case a new value for the cluster dimension is needed, a unique identifier may be generated as known in the art. Clustering module stores the (augmented) analytics use case descriptions in the data store e.g. that shown in FIG. 9a.

12. The Clustering Module triggers the Categorization Module e.g. by directly providing all analytics use case descriptions to the Categorization Module.

13. Categorization Module reads all available analytics use case descriptions from the data store, at least if the descriptions were not passed directly.

14. Categorization Module reads all available Execution environment descriptions from the data store e.g. from the configuration descriptions.

15. If not already there, Categorization Module augments the analytics use case descriptions by a “category” field. Typically, for all analytics use case descriptions with the same cluster, Categorization Module matches the dimensions against the dimensions of all existing execution environments. Typically, if there is an exact match, the ID of the respective execution environment is set as the category in the respective analytics use case descriptions. Typically if there is not an exact match, the ID of an execution environment that, due to configuration, may run the analytics (e.g. all analytics smaller an equal to a given environment dimension) is set as the category in the respective analytics use case descriptions. In case of multiple environments being possible for a cluster, then subject to configuration the following options may be considered: use environments that are already assigned before assigning new ones, use always the environments with the least cost, choose randomly, other techniques known in the art. In case there is no match achievable, the category stays empty or gets a special value indicating “no match”.

16. Categorization Module stores the (augmented) analytics use case descriptions, including category field, in the Data Store and typically also outputs the descriptions to a defined interface.

Any suitable treatment may be employed to handle cases in which entire dimensions existing in some of the descriptions are not present in other descriptions (or in which specific dimension values existing in some of the descriptions are not present in other descriptions). One default option is refusing to match such dimensions (or dimension values). Another possibility is ignoring unknown dimensions (or dimension values), suitable if missing may safely be assumed to indicate “unimportant, everything allowed.” Another possibility is to establish a binary “critical yes/no” field for each dimension (or dimension values), indicating if the dimension (or dimension values) can or cannot be ignored. Or define explicit rules within the configuration how to handle absence of certain dimensions (or dimension values), or any other solution strategy known in the art.

It is appreciated that the embodiments herein may apply to any suitable application e.g. (analytics) use case (e.g. referring to a certain kind of analytics) not just to examples thereof appearing herein.

It is appreciated that the embodiments herein may apply to any suitable platform e.g. “analytics platform”, not just to examples thereof appearing herein.

It is appreciated that the embodiments herein may apply to any suitable execution environment not just to examples thereof appearing herein.

It is appreciated that the embodiments herein may apply to any suitable scenario not just to examples thereof appearing herein, such as basketball and industry.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The system may if desired be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true and never by determinations that x is false.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order, may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting. Headings and sections herein as well as numbering thereof, is not intended to be interpretative or limiting.

1. An analytics assignment system (aka assistant) serving a software e.g. IoT analytics platform which operates intermittently on plural use cases, the system comprising:
a. an interface receiving
a formal description of the use cases including a characterization of each use case along predetermined dimensions; and
a formal description of the platform's possible configurations including a formal description of plural execution environments supported by the platform including for each environment a characterization of the environment along said predetermined dimensions; and
b. a categorization module including processor circuitry operative to assign an execution environment to each use-case,
wherein at least one said characterization is ordinal thereby to define, for at least one of said dimensions, ordinality comprising “greater than >/less than </equal=” relationships between characterizations along said dimensions, and wherein said ordinality is defined, for at least one dimension, such that if the characterizations of an environment along at least one of said dimensions are respectively no less than (>=) the characterizations of a use case along at least one of said dimensions, the environment can be used to execute the use case,
and wherein the categorization module is operative to generate assignments which assign to at least one use-case U, an environment E whose characterizations along each of said dimensions are respectively no less than (>=) the characterizations of the use case U along each of said at least one dimensions.

2. A system according to claim 1 and wherein the categorization module is operative to generate assignments which assign to each use-case U, an environment E whose characterizations along each of said dimensions are respectively no less than (>=) the characterizations of the use case U along each of said dimensions.

3. A system according to claim 1 and wherein the categorization module is operative to generate assignments which assign to at least one use-case U, an environment E whose characterizations along each of said dimensions are respectively equal to (=) the characterizations of the use case U along each of said dimensions.

4. A system according to claim 1 and wherein the categorization module is operative to generate assignments which assign to at least one use-case U, an environment E whose characterizations along at least one of said dimensions is/are respectively greater than (>) the characterizations of the use case U along each of said dimensions.

5. A system according to claim 1 and wherein each said characterization is ordinal thereby to define, for each of said dimensions, ordinality comprising “greater than >/less than </equal=” relationships between characterizations along said dimensions.

6. A system according to claim 1 and wherein said ordinality is defined, for each dimension, such that if the characterizations of an environment along each of said dimensions are respectively no less than (>=), the characterizations of a use case along each of said dimensions, the environment can be used to execute the use case.

7. A system according to claim 1 and wherein said dimensions include a state dimension whose values include at least one of stateless and stateful.

8. A system according to claim 1 and wherein said dimensions include a time constraint dimension whose values include at least one of Batch, streaming, long time, near real time, real time.

9. A system according to claim 1 and wherein said dimensions include a data granularity dimension whose values include at least one of Data point, data packet, data shard, and data chunk.

10. A system according to claim 1 and wherein said dimensions include an elasticity dimension whose values include at least one of Resource constrained, single server, cluster of given size, 100% elastic.

11. A system according to claim 1 and wherein said dimensions include a location dimension whose values include at least one of Edge, on premise, and hosted.

12. A system according to claim 1 which also includes a classification module including processor circuitry which classifies at least one use case along at least one dimension.

13. A system according to claim 1 which also includes a clustering module including processor circuitry which joins use cases into a cluster if and only if the use cases all have the same values along all dimensions.

14. A system according to claim 1 which also includes a configuration module including processor circuitry which handles system configuration.

15. A system according to claim 1 which also includes a data store which stores at least said use-cases and said execution environments.

16. A system according to claim 1 wherein said platform intermittently activates environments supported thereby to execute use cases, at least partly in accordance with said assignments generated by said categorization module, including executing at least one specific use-case using the execution environment assigned to said specific use case by said categorization module.

17. An analytics assignment method serving a software e.g. IoT analytics platform which operates intermittently on plural use cases, the method comprising:
a. receiving, via an interface
a formal description of the use cases including a characterization of each use case along predetermined dimensions; and
a formal description of the platform's possible configurations including a formal description of plural execution environments supported by the platform including for each environment a characterization of the environment along said predetermined dimensions; and
b. providing a categorization module including processor circuitry operative to assign an execution environment to each use-case,
wherein at least one said characterization is ordinal thereby to define, for at least one of said dimensions, ordinality comprising “greater than >/less than </equal=” relationships between characterizations along said dimensions, and wherein said ordinality is defined, for at least one dimension, such that if the characterizations of an environment along at least one of said dimensions are respectively no less than (>=) the characterizations of a use case along at least one of said dimensions, the environment can be used to execute the use case,
and wherein the categorization module is operative to generate assignments which assign to at least one use-case U, an environment E whose characterizations along each of said dimensions are respectively no less than (>=) the characterizations of the use case U along each of said at least one dimensions.

18. A computer program product, comprising a non-transitory tangible computer readable medium having computer readable program code embodied therein, said computer readable program code adapted to be executed to implement an analytics assignment method serving a software platform which operates intermittently on plural use cases, the method comprising:
a. receiving, via an interface
a formal description of the use cases including a characterization of each use case along predetermined dimensions; and
a formal description of the platform's possible configurations including a formal description of plural execution environments supported by the platform including for each environment a characterization of the environment along said predetermined dimensions; and
b. providing a categorization module including processor circuitry operative to assign an execution environment to each use-case,
wherein at least one said characterization is ordinal thereby to define, for at least one of said dimensions, ordinality comprising “greater than >/less than </equal=” relationships between characterizations along said dimensions, and wherein said ordinality is defined, for at least one dimension, such that if the characterizations of an environment along at least one of said dimensions are respectively no less than (>=) the characterizations of a use case along at least one of said dimensions, the environment can be used to execute the use case,
and wherein the categorization module is operative to generate assignments which assign to at least one use-case U, an environment E whose characterizations along each of said dimensions are respectively no less than (>=) the characterizations of the use case U along each of said at least one dimensions.
